(19) United States
(12) Patent Application Publication
(10) Pub. No.: US 2015/0237351 A1
(43) Pub. Date: Aug. 20, 2015

(54) TECHNIQUES FOR INCLUSION OF REGION OF INTEREST INDICATIONS IN COMPRESSED VIDEO DATA

(71) Applicants: PENNE LEE, Bellevue, WA (US); CHANGLIANG WANG, Bellevue, WA (US); YI-JEN CHIU, San Jose, CA (US)

(72) Inventors: PENNE LEE, Bellevue, WA (US); CHANGLIANG WANG, Bellevue, WA (US); YI-JEN CHIU, San Jose, CA (US)

(21) Appl. No.: 14/183,026

(22) Filed: Feb. 18, 2014

(51) Int. Cl. H04N 19/167; H04N 19/156; H04N 19/20; H04N 19/127

(52) U.S. Cl. CPC H04N 19/167; H04N 19/127; H04N 19/156; H04N 19/20

(57) ABSTRACT

Various embodiments are generally directed to techniques for incorporating indications of regions of interest (ROIs) into a video bitstream of compressed video frames representing images of a motion video in compressed form. A device to compress motion video images includes a compression component to compress an image of a motion video to generate compressed video data representing the motion video, the image comprising a region of interest (ROI); and an augmenting component to augment the compressed video data with an indication of a location of a boundary of the ROI in the image. Other embodiments are described and claimed.

### BACKGROUND

The increasing color depth and resolution with which motion video imagery is digitally captured, stored and viewed now rivals the quality of film-based photography at even a professional level in which expectations of sharpness and color reproduction are heightened. However, these increases also result in increased data sizes, resulting in increased storage capacity requirements for storage devices and increased data transfer rate requirements for the exchange of data that includes motion video.

Various types of video compression have been employed in the storage and transmission of compressed video data that represents motion video. Among those types of video compression are versions of the widely used Motion Picture Experts Group (MPEG) specification promulgated by the International Organization for Standardization of Geneva, Switzerland. Specifically, versions of MPEG known widely as MPEG 2 and MPEG 4 (also known as H.264) are widely used in transmitting motion video via satellite, over-the-air and cable-based distribution systems, and as streamed video data via networks (e.g., the Internet). Currently under development is a new version of MPEG known among its developers as high-efficiency video coding (“HEVC”) or “H.265” that updates various aspects of MPEG to better address the commonplace adoption of “high definition” television resolutions.

Unfortunately, the coming of so-called “4K” resolution (e.g., 3840×2160 pixels) motion video makes clear that increases in data sizes will continue to challenge the pace at which motion video compression algorithms are able to be improved to reduce data sizes through compression. As a result still other approaches to reducing data sizes are being sought. One approach of recent interest is the designation of one or more portions of one or more frames of motion video imagery as a region of interest (ROI) such that compression of those frames may be better optimized to at least allow portions of frames not deemed to be as important to be more aggressively compressed to further reduce data sizes. Other portions of such frames that are deemed to be of greater importance may be less aggressively compressed and/or may be allowed to be represented with a greater color depth.

Although the designation of ROIs coincident with the generation of motion video has begun to be used effectively in controlling initial encoding to compress that motion video, what portion(s) of each frame of a motion video are or are not a ROI must currently be re-derived at any stage of storage, transmission or other processing at which the motion video is decoded and/or re-encoded. This includes transcoding to alter aspects of a motion video (e.g., change resolution or color depth, cropping or rescaling, adding of subtitles, etc.) and decoding to decompress a motion video for viewing. Unfortunately, such re-deriving of ROIs entails the use of various algorithms that consume considerable processing, storage and/or power resources, which may become quickly unsustainable in devices with limits on one or more of such resources, especially power.

### BRIEF DESCRIPTION OF THE DRAWINGS

FIG. 1 illustrates an embodiment of an image processing system.

FIG. 2 illustrates an alternate embodiment of an image processing system.

FIGS. 3A-B each illustrate an example embodiment of capturing an image and determining boundaries of a ROI within the image.

FIG. 4 illustrates an example embodiment of modifying boundaries of a ROI.

FIG. 5 illustrates an example embodiment of generating compressed video data.

FIG. 6 illustrates an example embodiment of generating message data.

FIG. 7 illustrates an example embodiment of modifying specifications of boundaries of a ROI.

FIGS. 8-10 each illustrate a portion of an embodiment.

FIGS. 11-13 each illustrate a logic flow according to an embodiment.

FIG. 14 illustrates a processing architecture according to an embodiment.

FIG. 15 illustrates another alternate embodiment of a graphics processing system.

FIG. 16 illustrates an embodiment of a device.

### DETAILED DESCRIPTION

Various embodiments are generally directed to techniques for incorporating indications of regions of interest (ROIs) into a video bitstream of compressed video frames representing images of a motion video in compressed form. More specifically, indications of ROIs for at least a subset of the images of the motion video are incorporated into the video bitstream along with indications of resolution, color depth, temporal ordering and various compression parameters. In some embodiments, the indications of ROIs may take the form of messages formatted and/or organized to adhere to specifications for messages of one or more widely known and used types of video compression to allow those indications to be included as messages among other messages indicating various aspects of the video frames and/or their compression. Causing the indications of ROIs to take the form of messages adhering to one or more of such specifications may enable the indications to be incorporated into a video bitstream of compressed frames in a manner accepted as part of one or more of such specifications and/or may enable the indications to be so incorporated as an optional feature that at least mitigates incompatibility with one or more of such specifications.

In some embodiments, a version of MPEG or similar type of compression may be employed to compress the video frames. In such embodiments, a series of video frames may be compressed to generate compressed frames (e.g., intra-frames (I-frames), predicted frames (P-frames) and/or bi-predicted frames (B-frames)) organized into a group-of-pictures (GOP). A video bitstream may incorporate a series of numerous GOPs, and those GOPs may be organized in chronological order while the compressed frames inside each GOP are arranged in a coding order.

In various embodiments, each such indication of a ROI may apply to only one compressed frame or to multiple compressed frames. Where such an indication applies to multiple compressed frames, the compressed frames to which it applies may be individually identified, may be identified as a quantity of compressed frames starting with a specifically identified compressed frame, or may be identified by specifying the one or more GOPs into which the compressed frames may be organized.

In various embodiments, each such indication of an ROI may specify the location of boundaries of the ROI in the image(s) represented by the compressed frames to which it applies by specifying those locations in terms of pixels and/or in terms of blocks of pixels from an edge or corner of the image(s). In some embodiments specification of the location of boundaries of an ROI in terms of both pixels and blocks may be employed to better enable processing of the images represented by those compressed frames.

In embodiments in which there may be more than one ROI indicated as present in an image of a compressed frame, each such ROI may be associated with a priority level indicative of the degree of importance of its content versus the content of one or more other ROIs in the same image. Such priority levels may be employed to control aspects of compression of portions of the image that are within each of the ROIs (e.g., how aggressively each of those portions is compressed). Such priority levels may include a lower priority level designating a portion of the image as less important than other portions not included in any ROI, as well as including a higher priority level designating a portion of the image as more important than other portions not included in any ROI. Association of a ROI with such a lower priority level may cause the portion of the image within that ROI to be compressed in an even more aggressive manner that may be more lossy than the compression employed for other portions not included in any ROI.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

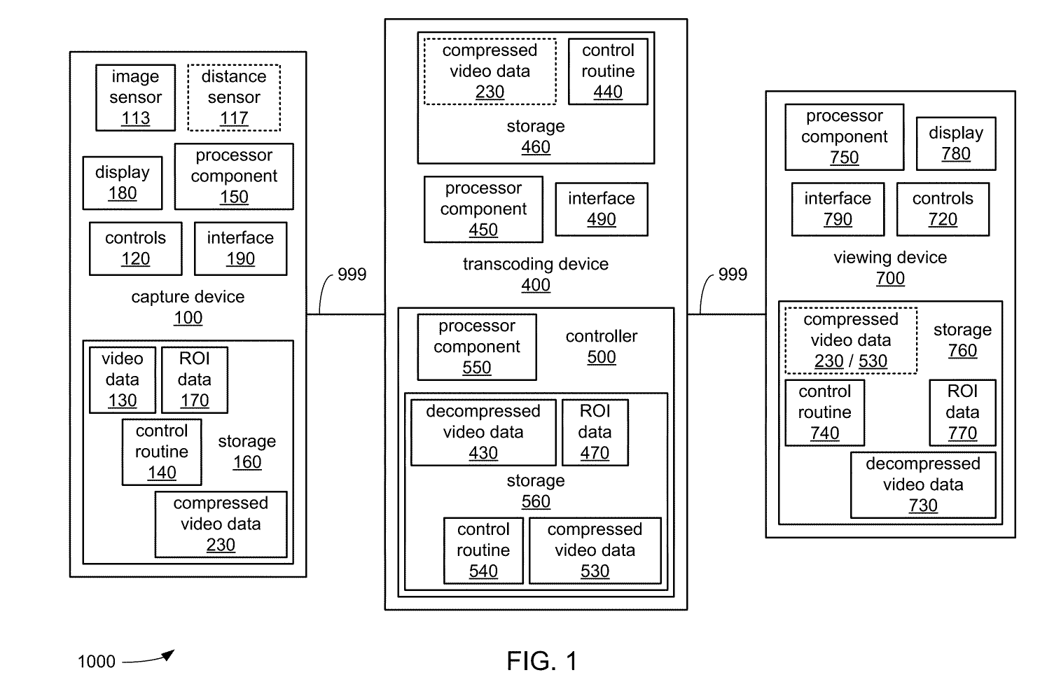

FIG. 1 illustrates a block diagram of an embodiment of an image processing system 1000 incorporating one or more of a capture device 100, a transcoding device 400 and a viewing device 700. In the image processing system 1000, compressed video data 230 that represents a motion video 880 in compressed form may be generated by the capture device 100. The compressed video data 230 may then be received from the capture device 100 and images of the motion video 880 may be modified by the transcoding device 400 in various ways to generate compressed video data 530 representing the motion video 880 in modified and compressed form. The viewing device 700 may receive either the compressed video data 230 or the compressed video data 530 from either the capture device 100 or the transcoding device 400, respectively, for visual presentation. Each of these devices 100, 400 and 700 may be any of a variety of types of computing device, including without limitation, a desktop computer system, a data entry terminal, a laptop computer, a netbook computer, a tablet computer, a handheld personal data assistant, a smartphone, smart glasses, a smart wristwatch, a digital camera, a body-worn computing device incorporated into clothing, a computing device integrated into a vehicle (e.g., a car, a bicycle, a wheelchair, etc.), a server, a cluster of servers, a server farm, etc.

As depicted, these devices 100, 400 and/or 700 exchange signals conveying compressed and/or uncompressed data representing the motion video 880 and/or related data through a network 999. However, one or more of these computing devices may exchange other data entirely unrelated to the motion video 880 with each other and/or with still other computing devices (not shown) via the network 999. In various embodiments, the network 999 may be a single network possibly limited to extending within a single building or other relatively limited area, a combination of connected networks possibly extending a considerable distance, and/or may include the Internet. Thus, the network 999 may be based on any of a variety (or combination) of communications technologies by which signals may be exchanged, including without limitation, wired technologies employing electrically and/or optically conductive cabling, and wireless technologies employing infrared, radio frequency or other forms of wireless transmission. It should also be noted that such data may alternatively be exchanged via direct coupling of a removable storage (e.g., a solid-state storage based on FLASH memory technology, an optical disc medium, etc.) at different times to each.

In various embodiments, the capture device 100 incorporates one or more of a processor component 150, a storage 160, controls 120, a display 180, an image sensor 113, a distance sensor 117, and an interface 190 to couple the capture device 100 to the network 999. The storage 160 stores one or more of a control routine 140, video data 130, ROI data 170 and compressed video data 230. The image sensor 113 may be based on any of a variety of technologies for capturing images of a scene, including and not limited to charge-coupled device (CCD) semiconductor technology. If present, the distance sensor 117 may be based on any of a variety of technologies for determining at least the distance of at least one object in the field of view of the image sensor 113 from the capture device 100. In some embodiments, a combination of ultrasonic output and reception may be used in which at least such a distance may be determined by projecting ultrasonic sound waves towards that object and determining the amount of time required for those sound waves to return after being reflected by that object. In other embodiments, a beam of infrared light may be employed in a similar manner in place of ultrasonic sound waves. Still other technologies to determine the distance of an object from the capture device 100 will occur to those skilled in the art.

The control routine 140 incorporates a sequence of instructions operative on the processor component 150 in its role as a main processor component of the capture device 100 to implement logic to perform various functions. In executing a sequence of instructions of the control routine 140, the processor component 150 is caused to capture a series of images making up the motion video 880 and to compress those images as compressed frames of a video bitstream. In so doing, the processor component 150 is also caused to determine whether there is at least one ROI in each of those images and the location of the boundaries of each such ROI. It should be noted that there may be numerous images among the series of images in a motion video that have one or more ROIs along with numerous images in the same series of images that do not have any ROIs, depending on the content of each of the images. Given the relatively high frame rates used in current motion video photography, multiple consecutive images of a motion video may have a ROI with the same boundaries (e.g., boundaries defining the same size and same of area, and at the same locations) as a result of the relatively slow speeds at which most real world objects move in most motion videos. Thus, as will be explained in detail, it may be common for ROIs to “persist” across multiple consecutive images of a motion video as a result of objects tending to remain in the same location across multiple consecutive images in many real world motion videos.

The capturing of images of the motion video 880 and determination of the presence and/or location of boundaries of ROIs in each of those captured images thereof may be triggered by receipt of a command to do so. More specifically, the processor component 150 may await a signal conveying a command to the capture device 100 to operate at least the image sensor 113 to capture images of the motion video 880 and store those captured images as frames of the video data 130. The signal may be received from the controls 120 and represent manual operation of the controls 120 by an operator of the capture device 100. Alternatively, the signal may be received from another device, and may be so received through the network 999. In addition to capturing the motion video 880 in response to the signal, the processor component 150 may also analyze objects in the field of view of the image sensor 113 and/or distances detected by the distance sensor 117 to those objects to derive one or more of the ROIs and/or to determine locations of boundaries for one or more of the ROIs.

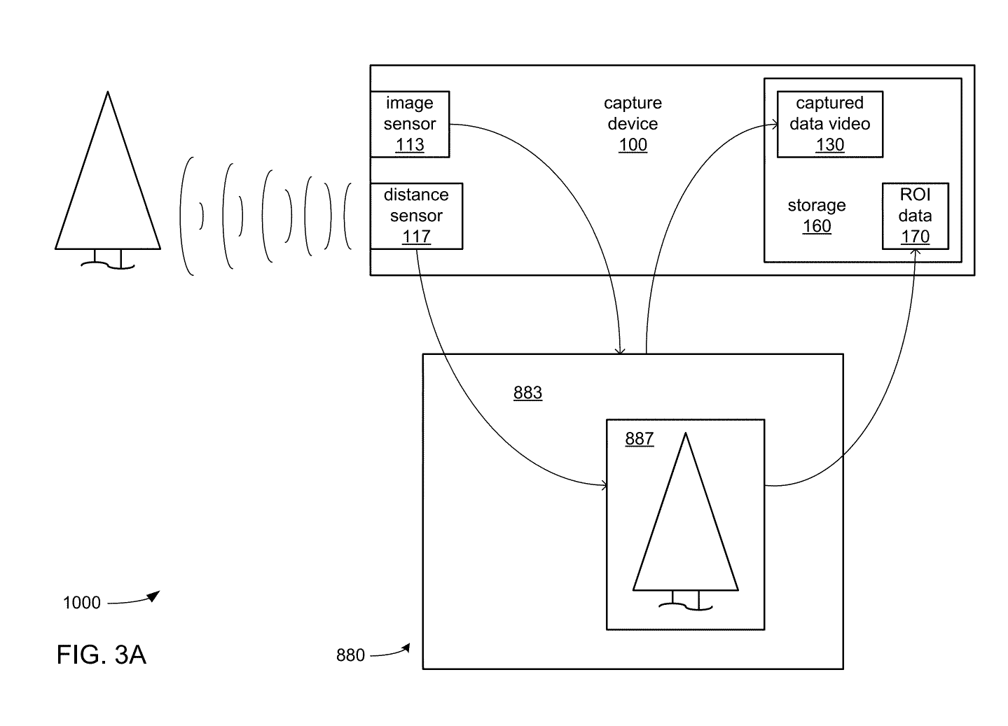

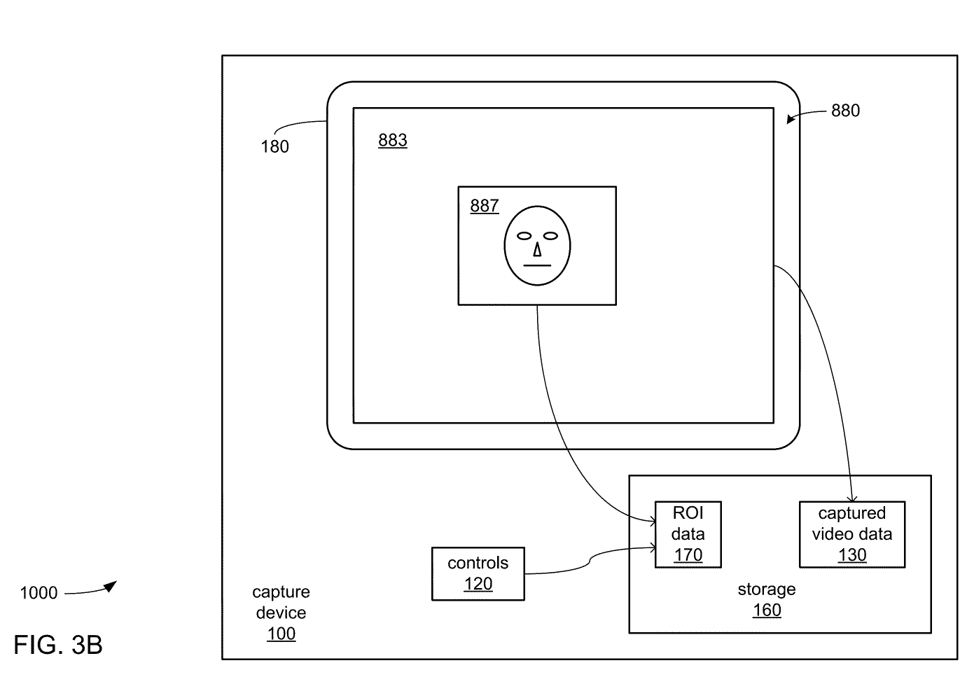

FIG. 3A depicts an example of capturing one image 883 of a series of images 883 making up the motion video 880 and determining a location of a ROI 887 within at least the depicted image 883 in greater detail. In embodiments of the capture device 100 that support automated focus, the processor component 150 operates the distance sensor 117 to determine the distance between the capture device 100 and an object (e.g., the depicted tree) in the field of view of the image sensor 113 that is to become the image 883. The processor component 150 may operate focusing components or other components associated with the image sensor 113 to adjust the focus for this determined distance.

In some possible implementations, the distance sensor 117 may be operated to determine the distance from the capture device 100 to the object in the field of view of the image sensor 113 that is closest to the capture device 100. In such implementations, the distance sensor 117 may have some ability to be used to determine the location and size of that closest object, and the processor component 150 may determine the boundaries of the ROI 887 to encompass at least a portion of that closest object within the image 883 captured of that field of view.

In other possible implementations, the distance sensor 117 may be operated to determine the distance between the capture device 100 and an object in the center of the field of view of the image sensor 113, regardless of the distance between the capture device 100 and any other object in that field of view. Such implementations may reflect a presumption that at least the majority of the captured images 883 will be centered on an object of interest to whoever operates the capture device 100. In such implementations, the location of the ROI 887 may be defined as being at the center of the image 883 by default. However, the distance sensor 117 may have some ability to be used to determine size and/or shape of the object in the center of that field of view, thereby enabling the processor component 150 to determine the degree to which that object fills the field of view and ultimately enabling the processor component 150 to determine the boundaries of the ROI 887 within the image 883.

Thus, in such implementations, the distance sensor 117 may be used as an aid to determining the boundaries of the ROI 887 within the image 883 in addition to enabling a determination of distance to an object for other functions such as automated focus. With the focus adjusted (whether through use of the distance sensor 117, or not), the processor component 150 is caused by execution of the control routine 140 to operate the image sensor 113 to capture the image 883 of what is in the field of view of the image sensor 113.

FIG. 3B depicts an alternate example of capturing an image 883 of the motion video 880 and determining a location of a ROI 887 within the image 883 in greater detail. More specifically, regardless of whether the distance sensor 117 is present or is used to perform functions such automatically adjusting focus, other techniques may be used to determine the boundaries of the ROI of the image 883 that may not make use of the distance sensor 117.

In some possible embodiments, the processor component 150 may be caused to employ one or more algorithms to analyze objects in the field of view of the image sensor 113 to attempt to identify one or more particular types of objects based on a presumption that those types of objects are likely to be of interest to whoever is operating the capture device 100. Thus, for example, the processor component 150 may be caused to employ a face detection algorithm to search for faces in the field of view of the image sensor 113. Upon identifying a face in the field of view, the processor component 150 may be caused to define the boundaries of the ROI 887 within the image 883 to be take of that field of view to encompass that identified face.

In other possible embodiments, the processor component 150 may receive signals indicative of manual operation of the controls 120 by an operator of the capture device 200 to manually indicate the boundaries of the ROI 887. Such a manually provided indication may be in lieu of an automated determination of those boundaries, may be a refinement of such an automated determination of those boundaries and/or may be to specify the boundaries of an additional region of interest (not shown).

To capture the motion video 880, the processor component 150 repeatedly operates the image sensor 113 to capture a series of the images 883. In so operating the image sensor 113, the processor component 150 receives signals from the image sensor 113 conveying the captured images 883 and stores the series of captured images 883 as a series of uncompressed frames of the video data 130. Correspondingly, in embodiments that include the distance sensor 177, the processor component may repeatedly operate the image sensor 117 for each capture of each of the images 883 to determine distances, locations and/or sizes of objects in the field of view of the image sensor 113 to determine whether each of the captured images 883 includes a ROI and/or the boundaries thereof. The processor component 150 stores indications of the boundaries of ROIs 887 that may be present (whether determined to be present through operation of the distance sensor 117, or not) in one or more of the captured images 883 of the motion video 880 as the ROI data 170 for subsequent use in compressing the uncompressed frames of the video data 130 representing the motion video 880.

Returning to FIG. 1, and following storage of the video data 130 and the accompanying ROI data 170, the processor component 150 compresses the video data 130 to create the compressed video data 230 using any of a variety of compression encoding algorithms. More precisely, the processor component 150 compresses the uncompressed frames of the video data 130 that each represent one of the images 883 of the motion video 880 to generate corresponding compressed frames of the compressed video data 230. In some embodiments, the processor component 150 may use a compression encoding algorithm associated with an industry-accepted standard for compression of motion video, such as and not limited to H.263 or H.264 of various incarnations of MPEG (Motion Picture Experts Group) promulgated by ISO/IEC (International Organization for Standardization and the International Electrotechnical Commission), or VC-1 promulgated by SMPTE (Society of Motion Picture and Television Engineers).

In so compressing the video data 130, the processor component 150 uses the indications of the boundaries of ROIs 887 within at least some of the images 883 represented as uncompressed frames of the video data 130 to vary the degree of compression in generating the corresponding compressed frames of the compressed video data 230. Stated differently, for ones of the images 883 that include a ROI 887, the processor component 150 may be caused to compress portions of those images 883 that are within a ROI 887 to a different degree than other portions not within a ROI 887. For example, one or more parameters of the compression of a portion of an image 883 within a ROI 887 may differ from one or more corresponding parameters of the compression of a portion of the same image 883 not within a ROI 887. Such a difference in parameters may include one or more of a difference in color depth, a difference in color encoding, a difference in a quality setting, a difference in a quantization parameter, a difference in a parameter that effectively selects lossless or lossy compression, a difference in a compression ratio parameter, etc.

As a result, the pixels of such a one of the images 883 that are within a ROI 887 may be represented with a higher average of bits per pixel in compressed form within the compressed video data 230 than the pixels of the same image 883 that are not within that ROI 887. Stated differently, more information associated with pixels outside a ROI 887 in an image 883 is lost on average per pixel than for the pixels in the ROI 887 within the same image 883. Thus, at a later time when the compressed video data 230 is decompressed as part of viewing the motion video 880, the portion of an image within a ROI 887 of that image is able to be displayed with greater image quality (e.g., displayed with greater detail and/or color depth, etc.).

In some embodiments, at least some of the ROIs 887 may be associated with a priority level indicative of a relative degree of importance of its content relative to the degree of importance of portions of the images 883 not within a ROI 887 and/or relative to the content of other ROIs 887. Any of a variety of algorithms may be employed by the processor component 150 in determining the priority level of each of the ROIs 887. By way of example, the processor component 150 may derive priority levels based on relative distances of objects from the capture device 113, with closer objects associated with priority levels indicative of greater importance than objects further away from the capture device 100. Alternatively or additionally, priority levels for at least some ROIs 887 may be provided to the capture device 100 from another computing device via the network 999 or via operation of the controls 120. The degrees to which different portions of an image 883 that are within or outside of one or more ROIs 887 are compressed may be at least partly based on the priority levels associated with each of those portions, including priority levels associated with the one or more ROIs 887. A portion of an image 883 within a ROI 887 having a priority level indicative of relatively high importance may be compressed to a lesser degree so as to preserve more of its detail than another portion of the same image within a ROI 887 having a priority level indicative of less importance or another portion of the same image that is not within any ROI 887. Alternatively or additionally, a ROI 887 may be associated with a priority level that is actually indicative of relatively low importance compared even to a portion of an image that is not within any ROI 887, and such a lower importance indicated by the priority level may result in the portion within that ROI 887 being compressed to a greater degree (e.g., “more aggressively”) such that more of its detail is lost. In essence, a ROI 887 associated with a priority level indicative of such lesser importance may be deemed a “region of lesser interest” such the loss of its detail through more aggressive compression is deemed to not be of concern. As will be explained in greater detail, the designation of a portion of a series of images 883 as having a ROI 887 associated with a priority level indicative of lesser importance may be used where those images 883 are combined with other images where the ROI 887 of less importance denotes an area that will be overlain with at least a portion of a different image.

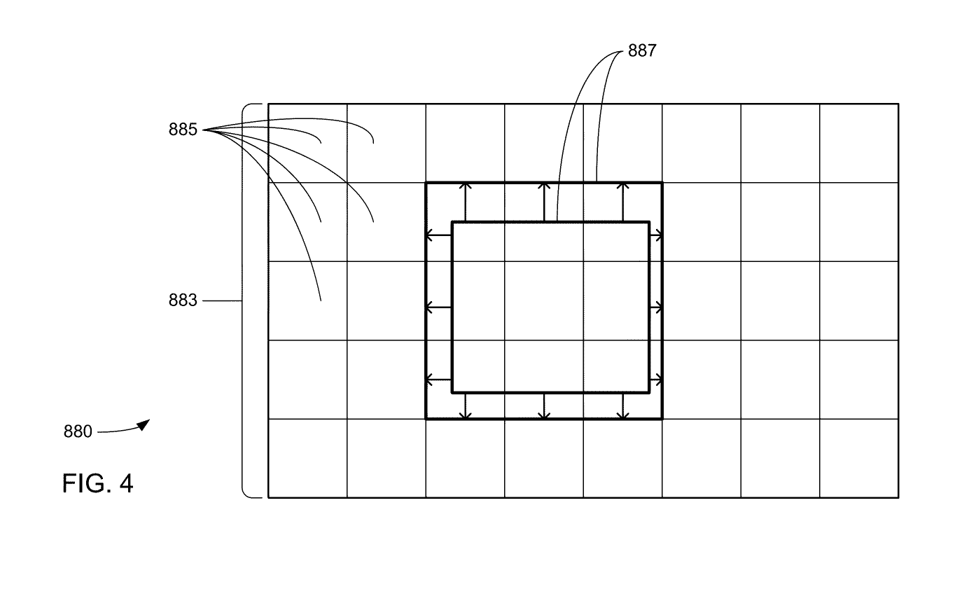

It should be noted that the choice of a compression encoding algorithm associated with an industry standard may result in the imposition of various requirements for characteristics of the compressed video data 230. Specifically, such an industry standard likely includes a specification concerning the manner in which portions of the data representing an image in compressed form are organized (e.g., contents of a header, messages of a message data, etc.), the order in which data associated with each pixel of an image is organized (e.g., a particular pattern of zigzag scanning, etc.), limitations on choices of available color depth and/or color encoding, etc. For example and as depicted in FIG. 4, some compression encoding algorithms may entail organizing the pixels of the images 883 into two-dimensional blocks 885 of pixels, such as the typical 8×8 pixel blocks or the typical 16×16 pixel “macroblocks” of various versions of MPEG. Further, some of such compression encoding algorithms require that all pixels within each such a block 885 be associated with a common color depth, common color encoding and/or other common compression-related parameters such that it is not possible to compress some of the pixels of a block 885 with at least some of the parameters differing from other pixels of that same block 885.

As a result, where the boundaries a ROI 887 do not align with boundaries of adjacent ones of the blocks 885, the boundaries of the ROI 887 may be altered by the processor component 150 to align with the boundaries of the blocks 885. In some embodiments, the processor component 150 shifts any unaligned ones of the boundaries of a ROI 887 towards the closest one of the boundaries of adjacent ones of the blocks 885, regardless of whether or not doing so increases or decreases the two-dimensional area of the ROI 887. In other implementations, the processor component 150 shifts any unaligned ones of the boundaries of a ROI 887 outward to the closest boundaries of adjacent ones of the blocks 885 that are outside of the original boundaries of the ROI 887 (as specifically depicted in FIG. 4) such that the two-dimensional area of the ROI 887 can only increase. This may be done to ensure that an object within that ROI 887 is not subsequently removed (either wholly or in part) from that ROI 887 as a result of its two-dimensional area shrinking. As an alternative, and presuming that the choice of compression encoding algorithm is known at the time of defining the boundaries of the ROIs 887, the boundaries of the ROIs 887 may be initially defined to align with ones of the boundaries of adjacent ones of the blocks 885 to avoid having to subsequently shift the boundaries of the ROIs 887 at a later time.

However, in other embodiments, the manner in which the boundaries of a ROI 887 of an image 883 are altered to align with the boundaries of adjacent ones of the blocks 885 may be at least partly controlled by the relative priority levels associated with that ROI 887 and at least the portions of the image 883 that are not within that ROI 887. By way of example, where that ROI 887 is associated with a priority level indicative of higher importance than the priority level of portions outside that ROI 887, then the boundaries of that ROI 887 may be shifted outwardly to align with the closest boundaries of adjacent ones of the blocks 885 to ensure that all of the contents of that ROI 887 are compressed in a manner consistent with their higher importance. However, where that ROI 887 is associated with a priority level indicative of lower importance than the priority level of portions outside that ROI 887, then the boundaries of that ROI 887 may be shifted inwardly to align with the closest boundaries of adjacent ones of the blocks 885 to ensure that all contents of portions outside that ROI 887 are compressed in a manner consistent with their higher importance.

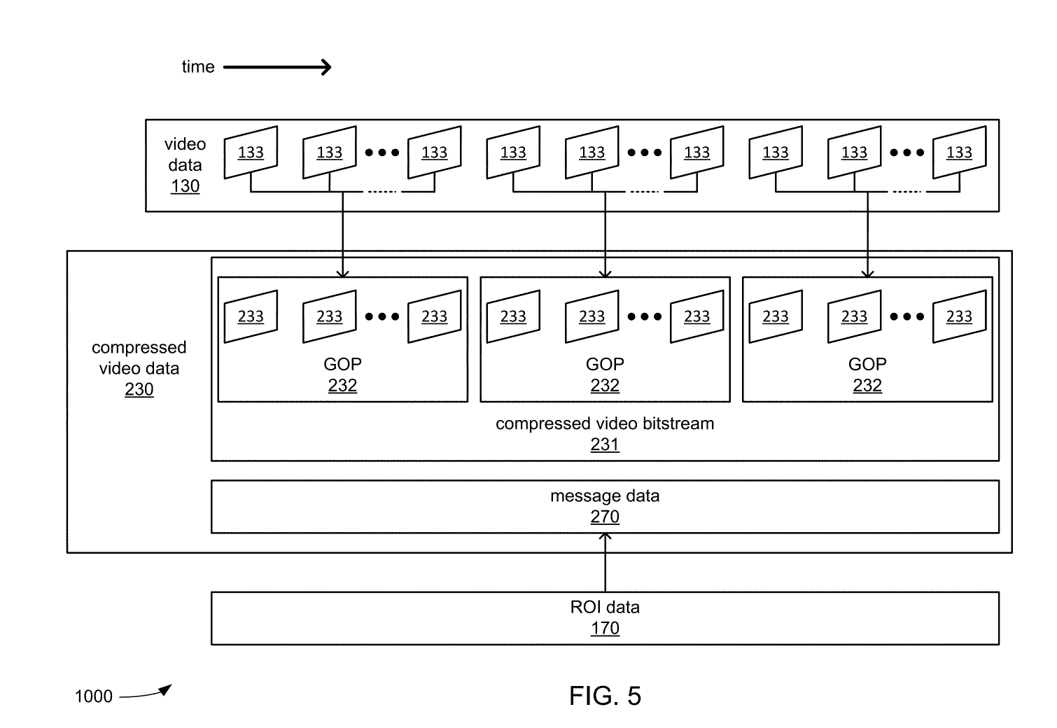

FIG. 5 illustrates an example embodiment of generating the compressed video data 230 from the video data 130 and the ROI data 170. As depicted, the video data 130 is made up of a series of frames 133 that each represent one of the images 883 of the motion video 880, and correspondingly, the compressed video data 230 is made up of compressed frames 233 that each correspond to one of the frame 133 and represent one of the images 883 of the motion video 880. As also depicted, a type of compression that entails the generation of groups of pictures (GOPs) is employed (e.g., a version of MPEG) such that the processor component 150 divides the frames 133 of the video data 130 into groups. Each such group of the frames 133 is then compressed to generate a GOP 232 made up of compressed frames 233 that correspond to those frames 133 of that group of the frames 133. The GOPs 232 are organized into a compressed video bitstream 231 that becomes the portion of the compressed video data 230 that represents the motion video 880 in compressed form.

The video data 230 also incorporates message data 270 that accompanies the compressed video bitstream 231 and includes indications of various parameters of the compression of the compressed frames 233, some of which are specified for individual ones of the compressed frames 233 and some of which are specified for one or more whole GOPs 232. The processor component 150 generates those indications and includes them within the message data 270 as the processor component 150 compresses the frames 133 to provide the information required for the subsequent decompression of the compressed frames 233. Such information may include color depth, color space encoding, quantization parameters, block sizes, etc. The processor component 150 may additionally include indications of the boundaries and/or priority levels of the ROIs 887 that may be included in at least some of the images 883 represented by the compressed frames 233.

As previously discussed, depending on the compression algorithm used, the boundaries of each ROI 887 may need to be altered to become aligned with boundaries of adjacent ones of the blocks 885 (e.g., MPEG macroblocks) into which each of the images 883 may be divided by in such compression algorithms. In some embodiments, the indications of locations of the boundaries of the ROIs 887 may specify the original unaltered locations of the boundaries of the ROIs 887 in terms of pixels from one or more selected edges and/or corners of the images 883 (e.g., a pixel-based two-axis Cartesian style coordinate system). In other embodiments, the indications of locations of the boundaries of the ROIs 887 may specify the locations of the boundaries of the ROIs 887 as altered to align with boundaries of adjacent ones of the blocks 885. In so doing, the boundaries of the ROIs 887 may be specified either in terms of pixels or in terms of blocks 885 from one or more selected edges and/or corners of the images 883. Alternatively, where the blocks 885 are provided with unique identifiers, the boundaries of the ROIs 887 may be specified in terms of which of the blocks 885 in each of the frames 883 are included in each of the ROIs 887. In still other embodiments, the indications of locations of the boundaries of the ROIs 887 may specify both the original unaltered locations and the altered locations of the boundaries of each of the ROIs 887, and may do so using a combination of quantities of pixels (e.g., a pixel-based coordinates) to specify the original unaltered locations and quantities of blocks 885 to specify the altered locations.

It should be noted that the frames 133 of the video data 130 representing the images 883 of the motion video 880 are arranged left-to-right in the chronological order in which the images 883 that they correspond to may have been captured by the capture device 100 (e.g., following the depicted “time” arrow in a direction from oldest to most recent). Further, the GOPs 232 may also be organized in the same chronological order, largely as a result of the chronological order of the groups of the frames 133 were compressed by the processor component 150. However, the compressed frames 233 within each of the GOPs 232 may be organized in a coding order in which ones of the compressed frames 232 that are used as reference frames by others of the compressed frames 232 precede those others of the compressed frames 232. As familiar to those skilled in the art, this is typically done to enable decompression to be performed at a relatively steady rate in which there is never an instance in which dependencies among the compressed frames 232 cause the decompression of one of the compressed frames 232 to be delayed until another of the compressed frames 232 is received by whatever device that performs the decompression.

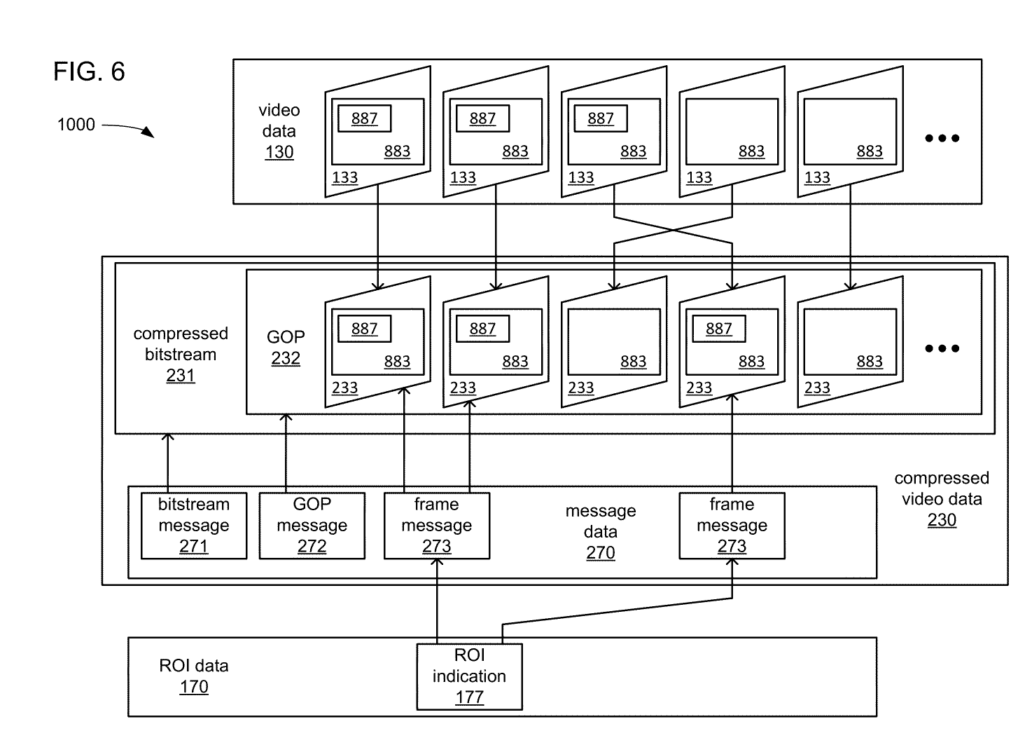

FIG. 6 illustrates an example embodiment of generating a single GOP 232 of the compressed video data 230 from the video data 130 in somewhat greater detail than FIG. 5. In particular, the generation of five compressed frames 233 in the depicted GOP 232 from five corresponding frames 133 of the video data 130 is depicted. Also depicted are an example set of possible messages of the message data 270 that may be generated by the processor component 150 along with the depicted compressed frames 233. As familiar to those skilled in the art, at least where the compressed video data 230 is generated to conform to one or more video compression standards (e.g., one or more versions of MPEG), the message data 270 may include messages providing indications of various aspects of compression, etc., relating to the entire compressed bitstream 231 generated to represent the motion video 880, including all of the compressed frames 233 thereof, such as the depicted bitstream message 271. Alternatively or additionally, the message data 270 may include messages providing such indications relating to an entire GOP 232, including all of the compressed frames 233 thereof, such as the depicted GOP message 272. Also alternatively or additionally, the message data 270 may include messages providing such indications relating to one or more individual ones of the compressed frames 233, such as the depicted frame messages 273. It should be noted that this particular depiction of generation of compressed frames 233 is a somewhat simplified depiction to facilitate discussion and understanding, and that it is generally expected that the GOP 232 would typically incorporate a larger series of compressed frames 233.

As has been discussed, the frames 133 of the video data 130 may be arranged in chronological order (depicted as progressing left-to-right from oldest to most recent), but the corresponding compressed frames 233 may be organized within the GOP 232 in a coding order. As specifically depicted in FIG. 6, a result of this possible difference in order may be that a pair of the compressed frames 233 are reversed in order within the GOP 232 relative to their corresponding pair of frames 133. As a result of this change in order, the three temporally consecutive images 883 that include the same ROI 887 with boundaries at the same locations, and which are represented by three consecutive ones of the frames 133, are caused to be represented by three non-consecutive compressed frames 233. More precisely, the aforementioned reversal of position of two of the compressed frames 233 into a coding order results in a compressed frame 233 representing an image 883 that does not include the ROI 887 being interposed between two of the three compressed frames 233 that represent ones of the three images 883 that do include the ROI 887.

As depicted, the ROI data 170 may contain a single indication 177 of the ROI 887 being present in the three consecutive images 883 represented by the three consecutive ones of the frames 133. By way of example, this single indication 177 may indicate the locations of the boundaries of the ROI 887, may specify the oldest of these three frames 133 (e.g., the leftmost one of these three) as representing an image 883 that includes the ROI 887, and may include a “persistence value” indicating that the ROI 887 is present in images 883 represented by a quantity of two more frames 133 following this oldest of the three frames 133. However, as a result of the consecutive arrangement of these three frame 133 not being preserved in the ordering of their corresponding ones of the compressed frames 233 within the GOP 232, the manner in which this ROI 887 is indicated as being present in the images 883 representing by the corresponding non-consecutive ones of the compressed frames 233 may change.

In some embodiments, and as depicted in FIG. 6, more than one frame message 273 may be generated within the message data 270 to indicate which of the compressed frames 233 represents an image 883 that includes this ROI 887. Specifically, one frame message 273 may be generated within the message data 270 that indicates that this ROI 887 is present in the image 883 represented by the oldest one of these three compressed frames 233 (e.g., the leftmost one of these three), and may include a persistence value indicating that this same ROI 887 is also present in the image 883 represented by a quantity of one more compressed frame 233 consecutively following this oldest the three compressed frames 233. Also, another frame message 273 may be generated within the message data 270 that indicates that this ROI 887 is present in the image 883 represented by the most recent one of these three compressed frames 233 (e.g., the rightmost one of these three), and may include a persistence value indicating that this same ROI 887 is not present in any image 883 represented by any compressed frame 233 consecutively following this most recent of the three compressed frames 233. Each of these two frame messages 273 may be generated entirely independently of each other within the message data 270, with neither making reference to the other, and each independently indicating the locations of the boundaries of this ROI 887.

In other embodiments where each of the compressed frames 233 are uniquely identifiable with an identifier or by relative position within the GOP 232, a single frame message 273 may be generated within the message data 270 that identifies each of the three compressed frames 233 that represents one of the three images 883 that includes this ROI 887. Thus, such a frame message 273 would not employ a persistence value at all. Such a frame message 273 would also indicate the locations of the boundaries of this ROI 887 in all three of these three images 883.

In embodiments in which the compressed bitstream 231 is generated from the video data 130 through use of a version of MPEG, such as H.265 (also known as HEVC), the messages 271, 272 and/or 273 that are generated in the message data 270 to indicate ROIs may employ a message syntax indicating that such messages are Supplemental Enhancement Information (SEI) messages. Such messages may employ a syntax compatible with such a version of MPEG, and such syntax may be used to specify the following parameters of such a message:
nal_unit_type=PREFIX_SEI_NUT (39)
payloadType=region_of_interest 235
payloadSize=variable
   The code 39 for nal_unit_type indicates that the message is a SEI message, the code 235 is an example of a reserved SEI message type code that may be allocated to designate a ROI message, and the code “variable” indicates that the message size (in bits) may vary from one instance of such a message to another.

Within such a message, the contents may be organized as indicated below, as described in syntax appropriate for use with a version of MPEG:

| | Descriptor |
|---|---|
| region_of_interest( payloadSize ) { | |
| roi_region_present_flag | u(1) |
| if ( roi_region_present_flag ) { | |
| num_roi_regions_minus1 | ue(v) |
| for ( i = 0; i <= num_roi_regions_minus1; i++) { | |
| roi_region_rect_top[i] | ue(v) |
| roi_region_rect_bottom[i] | ue(v) |
| roi_region_rect_left[i] | ue(v) |
| roi_region_rect_right[i] | ue(v) |
| roi_region_priority[i] | se(v) |
| } | |
| roi_region_persistence_flag | u(1) |
| } | |
| } | |

The semantics of such a message of the above syntax are as follows:

| | |
|---|---|
| roi_region_present_flag | When equal to 0, indicates that there is no ROI region |
| | information contained in the message, at all. When equal |
| | to 1, indicates that ROI region information follows. |
| num_roi_regions_minus 1 | Specifies the number of ROIs that are specified within the |
| | message. The range of values is 0 to 15, inclusive, and |
| | represents the number of ROIs subtracted by 1. |
| roi_rect_top[i] | Specifies the locations of the top, bottom, left and right |
| roi_rect_bottom[i] | boundaries of a ROI relative to the upper left corner of a |
| roi_rect_left[i] | frame (prior to any cropping). The range of values is 0 to |
| rot_rect_right[i] | 2¹³, inclusive, and represents quantities of pixels from the |
| | upper left corner. Accordingly, roi_rect_top[i] is always |
| | less than roi_rect_bottom[i], and both are always less than |
| | pic_height_in_luma_samples. Correspondingly, |
| | roi_rect_left[i] is always less than roi_rect_right[i], and |
| | both are always less than pic_width_in_luma_samples. |
| roi_region_priority[i] | Specifies the priority level of a ROI in relation to |
| | region(s) of a frame not within any ROI, which have a |
| | priority level of 0. The range of values is −16 to 16, |
| | inclusive, with larger positive values indicating a higher |
| | priority level than lower negative values. |
| roi_region_persistence_flag | When equal to 0, indicates that a ROI described in the |
| | message applies to only one frame. When equal to 1, |
| | indicates that a ROI described in the message applies to |
| | all frames going forward until the current bitstream ends, |
| | a new bitstream begins or there is a new SEI message |
| | describing one or more ROIs with a |
| | roi_region_persistence_flag equal to 1. |

Returning to FIG. 1, following the generation of the compressed video data 230 (including the message data 270 therein) from the video data 130 and the ROI data 170, the processor component 150 provides the compressed video data 230 to another device. The processor component 150 may do so by operating the interface 190 to transmit the compressed video data 230 to another device via the network 999. In some embodiments, the processor component 150 may transmit the compressed video data 230 to the transcoding device 400 and/or the viewing device 700 via the network 999. In other embodiments, the processor component 150 may store the compressed video data 230 onto a removable medium (not shown) that may subsequently be used to convey the compressed video data 230 to the transcoding device 400 and/or the viewing device 700.

The viewing device 700 incorporates one or more of a processor component 750, a storage 760, controls 720 and an interface 790 to couple the viewing device 700 to the network 999. The viewing device 700 may also incorporate a display 780 on which to visually present the motion video 880, or the display 780 may be physically separate from the viewing device 700, but be communicatively coupled thereto. The controls 720 may be any of a variety of manually-operable input devices by which an operator of the viewing device 700 may convey commands to select what is visually presented by the viewing device 700 on the display 780. For example, the controls 720 may include manually-operable controls carried by a casing of the viewing device 700, itself, and/or may include manually-operable controls carried by a remote control wirelessly coupled to the viewing device 700. The storage 760 stores one or more of the compressed video data 230 (or compressed video data 530), a control routine 740, decompressed video data 730 and ROI data 770.

The control routine 740 incorporates a sequence of instructions operative on the processor component 750 to implement logic to perform various functions. In executing the control routine 740, the processor component 750 may receive the compressed video data 230 from the capture device 100. Alternatively, the processor component 750 may receive the compressed video data 530 from the transcoding device 400, where the compressed video data 530 may be generated from modifications made to the compressed video 230 as will be explained in greater detail. Again, the compressed video data 230 or 530 may be received via the network 999 or by another mechanism, such as a removable storage medium. In executing the control routine 740, the processor component 750 decompresses whichever one of the compressed video data 230 or 530 is received. In so doing, the processor component 750 generates the decompressed video data 730 representing the motion vide 880 in decompressed form, and generates the ROI data 770 made up of indications of ROIs 887 present within the images 883 represented by the decompressed frames of the decompressed video data 730.

In some embodiments, the processor component 750 may employ the ROI data 770 to determine what portions of each of the images 883 at which one or more image enhancement techniques may be applied. By way of example, the processor component 750 may employ various smoothing, color correction or other image enhancement techniques only where a ROI 887 with a relatively high priority level is indicated in the ROI data 770 to be present as a way to allocate limited processing, storage and/or power resources in preparation for visually presenting the motion video 880. Alternatively or additionally, the processor component 750 may limit the analysis of each image 883 to identify faces to only portions of each image 883 at which a ROI 887 is indicated as present, and upon identifying a face within a ROI 887, the processor component 750 may apply a skin color enhancement algorithm.

The processor component 750 may monitor the controls 720 to receive indications of operation of the controls 720 to convey commands to cause the visual presentation of additional information along with the motion video 880 such as a channel number, a program description, text or graphics of an applet, etc. In so doing, the processor component 750 may employ the indications of locations of the boundaries of any ROIs 887 to determine where on the display 780 to visually present such additional information. By way of example, the processor component 750 may attempt to avoid positioning the visual presentation of such additional information at locations on the display 780 at which ROIs 887 are visually presented that are indicated in the ROI data 770 as having a relatively high priority level.

The transcoding device 400 incorporates one or more of a processor component 450, a storage 460, a controller 500 and an interface 490 to couple the transcoding device 400 to the network 999. The storage 460 stores one or more of the compressed video data 230 and a control routine 440. The controller 500 incorporates one or more of a processor component 550 and a storage 560. The storage 560 stores one or more of a control routine 540, decompressed video data 430, ROI data 470 and compressed video data 530.

The control routine 440 incorporates a sequence of instructions operative on the processor component 450 in its role as a main processor component of the transcoding device 400 to implement logic to perform various functions. In executing the control routine 440, the processor component 450 may receive the compressed video data 230 from the capture device 100. Again, the compressed video data 230 may be received via the network 999 or by another mechanism, such as a removable storage medium. It should be noted that the compressed video data 230 may be stored in the storage 460 for a considerable amount of time before any use is made of it, including decompression, modification, re-compression and/or transmission thereof. The processor component 450 then provides the compressed video data 230 to the controller 500.

The control routine 540 incorporates a sequence of instructions operative on the processor component 550 in its role as a controller processor component of the controller 500 of the transcoding device 500 to implement logic to perform various functions. In executing the control routine 540, the processor component 550 decompresses the compressed video data 230. In so doing, the processor component 550 generates the decompressed video data 430 representing the motion vide 880 in decompressed form, and generates the ROI data 470 made up of indications of ROIs 887 present within the images 883 represented by the decompressed frames of the decompressed video data 430. The processor component 550 then performs any of a variety of image processing operations on the decompressed frames of the decompressed video data 430, and in so doing, may use and/or modify indications of ROIs 887 in the ROI data 470. The processing component 550 then compresses the decompressed frames of the video data 430 to generate the compressed video data 530. In so doing, the processor component 550 includes indications of the ROIs 887 from the ROI data 470 as additional messages in message data incorporated into the compressed video data 530 in a manner akin to the earlier described inclusion of such messages in the message data 270 of the compressed video data 230.

As familiar to those skilled in the art, video image processing operations that entail decompressing a motion video to perform image processing followed by again compressing it are often referred to as “transcoding” operations. Examples of possible image processing operations that the processor component 550 may perform as part of such transcoding may include resealing or cropping the images 883, converting between different frame rates by adding or removing images 883, augmenting at least some of the images 883 with additional visual information (e.g., subtitling), compositing the images 883 with images from another motion video (e.g., adding a picture-in-picture inset), etc. In embodiments in which the processor component 550 adds more visual content to at least some of the images 883 of the motion video 880 (e.g., subtitling text and/or an inset of images of another motion video), the processor component 550 may employ the indications of locations of the boundaries of any ROIs 887 in the ROI data 470 to determine where in the images 883 to make such additions. By way of example, the processor component 550 may attempt to avoid positioning such additional visual content at locations in the images 883 at which ROIs 887 are visually presented that are indicated in the ROI data 470 as having a relatively high priority level.

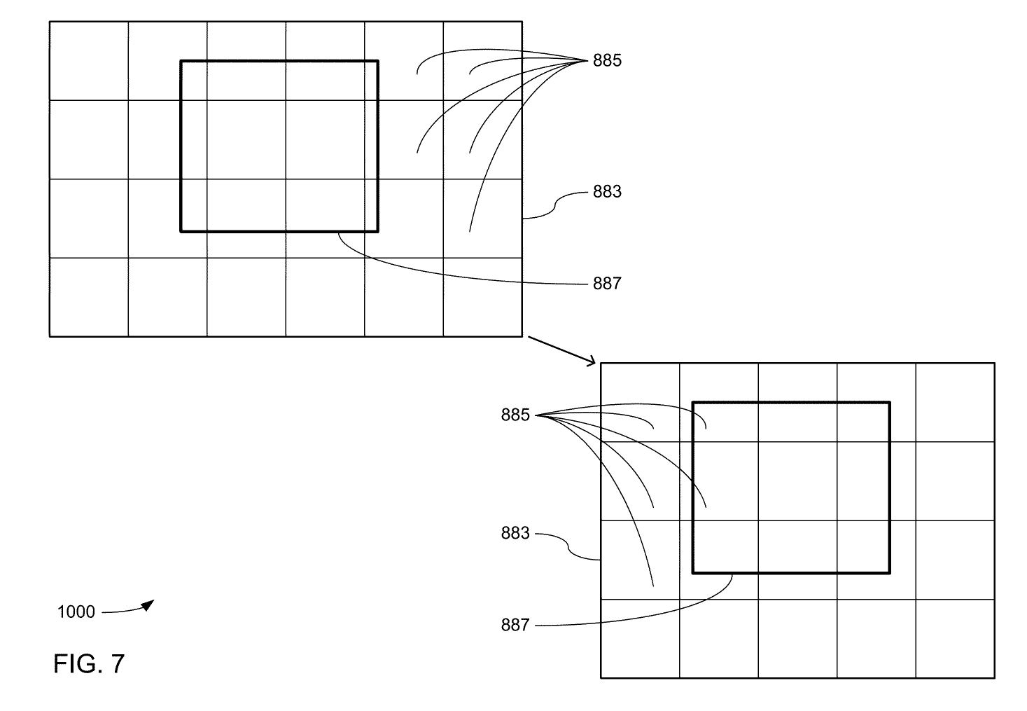

In embodiments in which the processor component 550 rescales or crops the images 883, the processor component 550 may modify the indications of locations of the boundaries of any ROIs 887 in the ROI data 470 to reflect what may be changes to quantities of pixels in one or both of the horizontal and vertical dimensions as a result of such modifications made to the frames 883. By way of example and as depicted in FIG. 7, the frames 883 may be cropped to reduce their width, and this cropping may be from the center of the originally wider frames 883 such that pixels at both the left and right ends are dropped. As a result, the indications of locations of the boundaries of any ROIs 887 in the frames 883 that are specified relative to an edge or corner of the frames 883 may need to be modified to reflect the resulting change in those relative measures arising from the dropping of pixels. As also shown in FIG. 7, specifying the locations of the boundaries of ROIs 887 in terms of quantities of pixels from an edge or corner of the frames 883 of those boundaries as unaltered to align with boundaries of adjacent ones of the blocks 885 may be deemed preferable. Doing so may more easily enable the subsequent aligning to new boundaries of adjacent ones of the blocks 885 following a possible shifting of the positions of the boundaries of adjacent ones of the blocks 885 as a result of cropping and/or resealing.

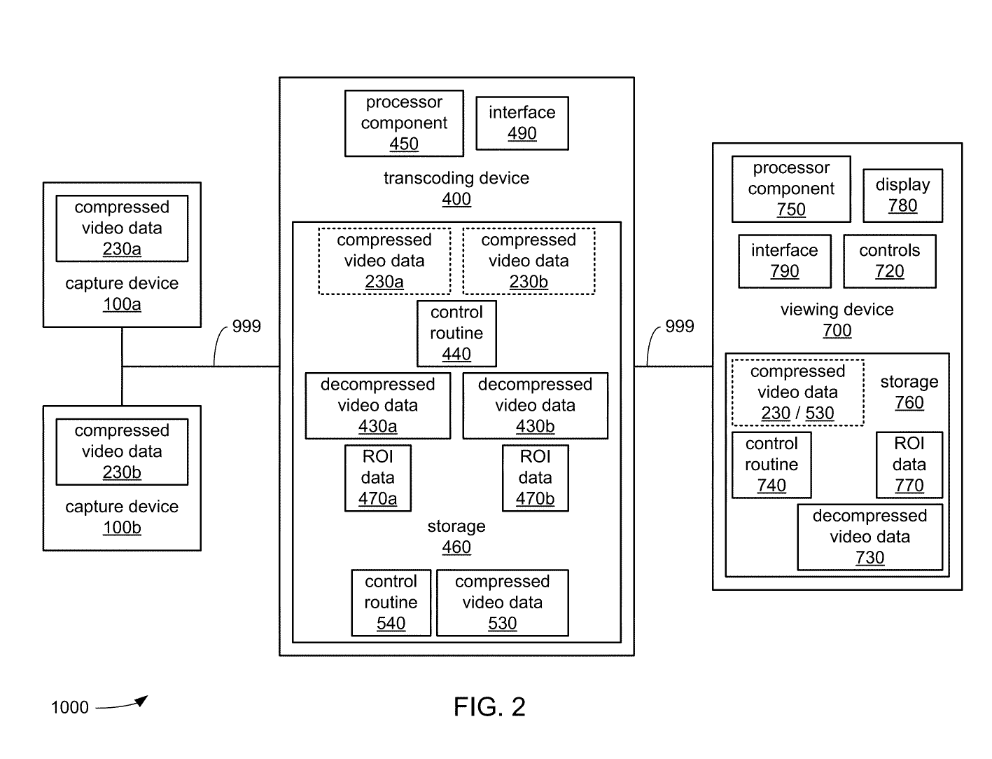

FIG. 2 illustrates a block diagram of an alternate embodiment of the video processing system 1000 that includes a pair of the capture devices 100a and 100b in place of the single capture device 100 of FIG. 1 and an alternate embodiment of the transcoding device 400. The alternate embodiment of the video processing system 1000 of FIG. 2 is similar to the embodiment of FIG. 1 in many ways, and thus, like reference numerals are used to refer to like elements throughout. However, unlike the transcoding device 400 of FIG. 1, the transcoding device 400 of FIG. 2 receives both compressed video data 230a and 230b from the capture devices 100a and 100b, respectively, instead of receiving only the compressed video data 230 from the capture device 100. Also, the transcoding device 400 does not incorporate the controller 500 such that unlike the transcoding device 400 of FIG. 1, in the transcoding device 400 of FIG. 2, it is the processor component 450 that executes the control routine 540 in lieu of there being a processor component 550 to do so. Thus, in the alternate embodiment of the video processing system 1000 of FIG. 2, the it is the processor component 450 that performs a transcoding operation, and that transcoding operation may be a combining of content of images represented by the compressed frames of each of the compressed video data 230a and 230b to generate the compressed video data 530.

More specifically, in executing the control routine 440, the processor component 450 receives both of the compressed video data 230a and 230b. The processor component 450 then decompresses both the compressed video data 230a and 230b to derive decompressed video data 430a and 430b and to derive ROI data 470a and 470b, respectively. The processor component 450 then combines at least a portion of the images represented by the decompressed frames of each of the decompressed data 430a and 430b to generate combined images that the processor component 450 then compresses to generate the compressed video data 530. In so doing, the processor component 450 may employ the indications of ROIs in each of the ROI data 470a and 470b to determine aspects of how to combine images represented by the decompressed frames of the decompressed video data 430a and 430b, respectively. By way of example, the processor component 450 may employ indications in the ROI data 470a of ROIs in the images represented by the decompressed frames of the decompressed video data 430a that are indicated to have a relatively low priority level as indications of where insets of at least portions of images represented by the decompressed frames of the decompressed video data 430b may be positioned. Alternatively or additionally, the processor component 450 may employ indications in the ROI data 470b of ROIs in the images represented by the decompressed frames of the decompressed video data 430b that are indicated to have a relatively high priority level as indications of what portions of the images represented by the decompressed frames of the decompressed video data 430b should be positioned within those insets.

In various embodiments, each of the processor components 150, 450, 550 and 750 may include any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are in some way linked.

Although each of the processor components 150, 450, 550 and 750 may include any of a variety of types of processor, it is envisioned that the processor component 550 of the controller 500 (if present) may be somewhat specialized and/or optimized to perform tasks related to graphics and/or video. More broadly, it is envisioned that the controller 500 embodies a graphics subsystem of the transcoding device 400 to enable the performance of tasks related to graphics rendering, video compression, image rescaling, etc., using components separate and distinct from the processor component 450 and its more closely related components.

In various embodiments, each of the storages 160, 460, 560 and 760 may be based on any of a wide variety of information storage technologies. Such technologies may include volatile technologies requiring the uninterrupted provision of electric power and/or technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, the interfaces 190, 490 and 790 may employ any of a wide variety of signaling technologies enabling these computing devices to be coupled to other devices as has been described. Each of these interfaces includes circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ signaling and/or protocols conforming to any of a variety of industry standards, including without limitation, RS-232C, RS-422, USB, Ethernet (IEEE-802.3) or IEEE-1394. Where the use of wireless signal transmission is entailed, these interfaces may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

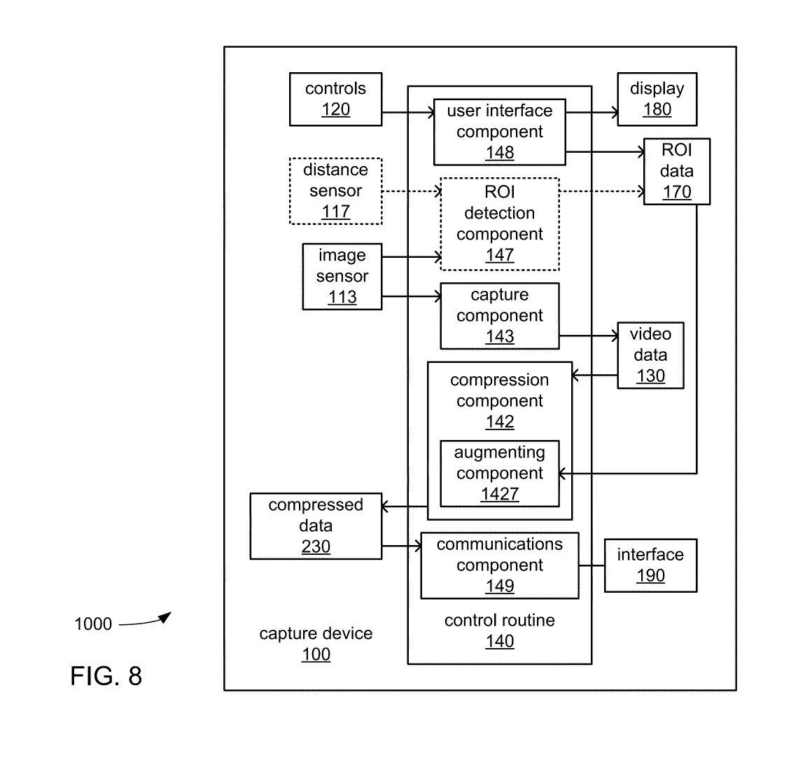

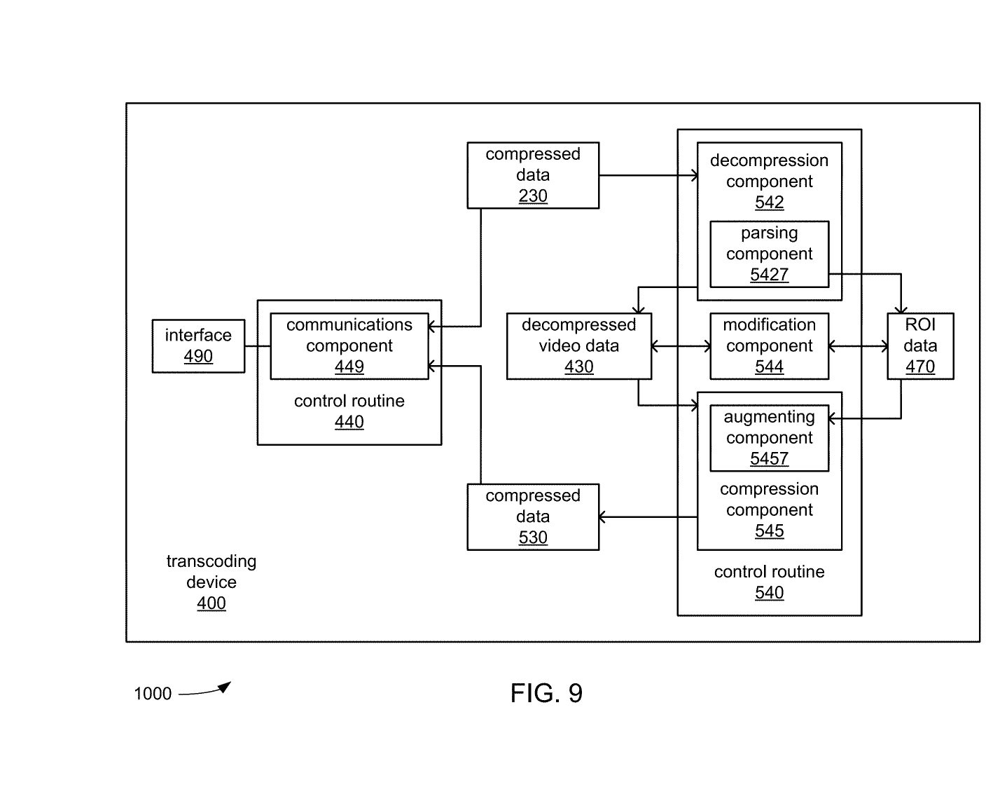

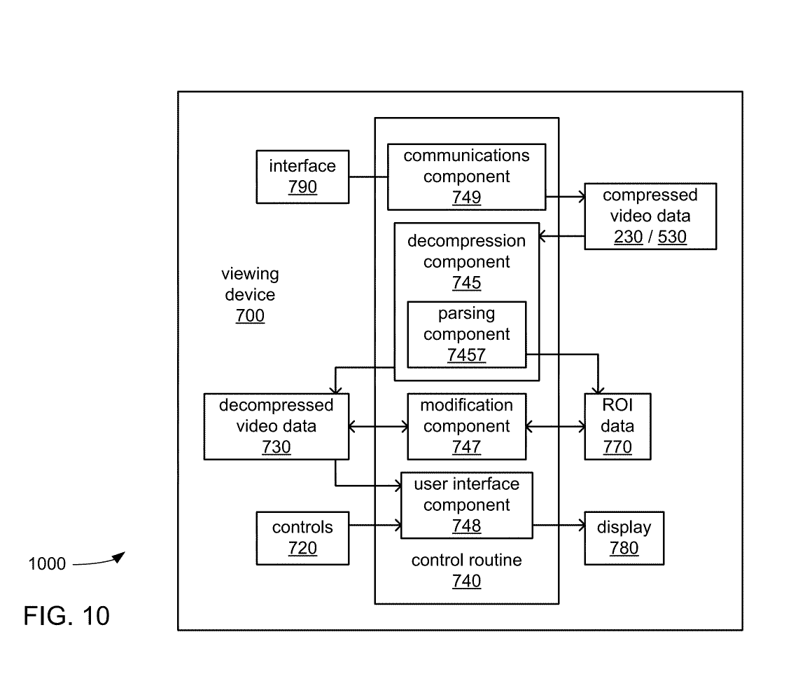

FIGS. 8, 9 and 10 each illustrate a block diagram of a portion of an embodiment of the video processing system 1000 of either FIG. 1 or FIG. 2 in greater detail. More specifically, FIG. 8 depicts aspects of the operating environment of the capture device 100 in which the processor component 150, in executing the control routine 140, captures the motion video 880, determines boundaries of the ROIs 887, and performs compression to generate the compressed video data 230. FIG. 9 depicts aspects of the operating environment of the transcoding device 400 in which the processor components 450 and/or 550, in executing the control routines 440 and/or 540, performs a transcoding operation entailing decompression of the compressed video data 230, modification of the motion video 880 in which indications of the ROIs 8887 are used and/or modified, and compression to generate the compressed video data 530. FIG. 10 depicts aspects of the operating environment of the display device 700 in which the processor component 750, in executing the control routine 740, decompresses the compressed video data 230 or 530, and visually presents the motion video 880 on the display 780 while making use of indications of the ROIs 887 in doing so. As recognizable to those skilled in the art, the control routines 140, 440, 540 and 740, including the components of which each is composed, are selected to be operative on whatever type of processor or processors that are selected to implement applicable ones of the processor components 150, 450, 550 or 750.

In various embodiments, each of the control routines 140, 440, 540 and 740 may include one or more of an operating system, device drivers and/or application-level routines (e.g., so-called “software suites” provided on disc media, “applets” obtained from a remote server, etc.). Where an operating system is included, the operating system may be any of a variety of available operating systems appropriate for whatever corresponding ones of the processor components 150, 450, 550 or 750. Where one or more device drivers are included, those device drivers may provide support for any of a variety of other components, whether hardware or software components, of corresponding ones of the computing devices 100, 400 or 700, or the controller 500.

The control routines 140, 440 or 740 may include a communications component 149, 449 or 749, respectively, executable by whatever corresponding ones of the processor components 150, 450 or 750 to operate corresponding ones of the interfaces 190, 490 or 790 to transmit and receive signals via the network 999 as has been described. Among the signals received may be signals conveying the compressed video data 230 and/or 530 among one or more of the computing devices 100, 400 or 700 via the network 999. As will be recognized by those skilled in the art, each of these communications components is selected to be operable with whatever type of interface technology is selected to implement corresponding ones of the interfaces 190, 490 or 790.

The control routines 140 or 540 may include a compression component 142 or 545, respectively, executable by whatever corresponding ones of the processor components 150, 450 or 550 to compress the video data 130 and the ROI data 170 to generate the compressed video data 230 or to compress the decompressed video data 430 and the ROI data 470 to generate the compressed video data 530. The compression components 142 or 545 may include an augmenting component 1427 or 5457, respectively, to augment the message data 270 and 570 incorporated within the compressed video data 230 and 530, respectively, with messages providing indications of the presence of, locations of boundaries for and/or priority levels of ROIs 887 that may be present in at least some of the images 883 of the motion video 880.

The control routines 540 or 740 may include a decompression component 542 or 745, respectively, executable by whatever corresponding ones of the processor components 450, 550 or 750 to decompress the compressed video data 230 to generate the decompressed video data 430 and the ROI data 470 or to decompress the compressed video data 530 to generate the decompressed video data 730 and the ROI data 770. The decompression components 542 or 745 may include a parsing component 5427 or 7457, respectively, to parse messages of the message data 270 or 570 to retrieve indications of the presence of, locations of boundaries for and/or priority levels of ROIs 887 that may be present in at least some of the images 883 of the motion video 880.

The control routines 540 or 740 may include a modification component 544 or 747, respectively, executable by whatever corresponding ones of the processor components 450, 550 or 750 to modify the decompressed video data 430 or 730 in any of a variety of ways, while using and/or modifying the accompanying ROI data 470 or 770, respectively. Among the modifications that may be made by the modification component 544 to images 883 represented by the decompressed frames of the decompressed video data 430 may be rescaling, cropping, addition of subtitles, combining with images from another motion video, etc. In making such modifications, the modification component 544 may additionally modify indications within the ROI data 470 of locations of boundaries of ROIs 887 to reflect changes in location of those ROIs 887 in the images 883 of the motion video 880 as a result of cropping, rescaling or other modifications made to the decompressed frames of the decompressed video data 430. Among the modifications that may be made by the modification component 747 to images 883 represented by the decompressed frames of the decompressed video data 730 may be smoothing, skin color adjustment, addition of other visual information requested by an operator of the viewing device 700, etc.

The control routines 140 or 740 may include a user interface component 148 or 748, respectively, executable by whatever corresponding ones of the processor components 150 or 750 to provide a user interface to control capturing and/or viewing of the motion video 880. The user interface component 148 may monitor the controls 120 and operate the display 180 to provide a user interface enabling an operator of the capture device 100 to specify the presence of, location of boundaries for, and/or priority levels of ROIs 887 in the images 883 of the motion video 880. The user interface component 748 may monitor the controls 720 and operate the display 780 to provide a user interface enabling an operator of the viewing device 700 to control modifications made by the modification component 747 to the visual presentation of the motion video 880 on the display 780.

The control routine 140 may include a capture component 143 executable by the processor component 150 to operate the image sensor 113 to capture the motion video 880, and thereby generate the video data 130. The control routine 140 may include a ROI detection component 147 to operate the distance sensor 117 (if present) to identify an object in the field of view of the image sensor 113 for which a ROI 887 is to be generated and/or to determine the size and/or location of an object in the field of view of the image sensor 113 to determine locations of boundaries for a ROI 887.

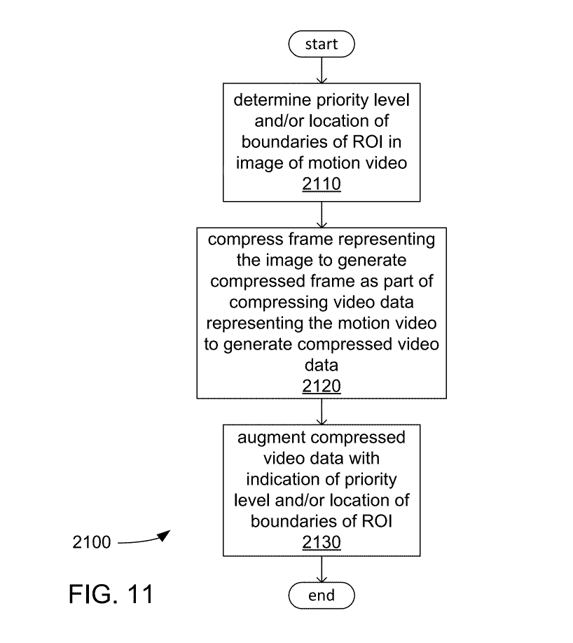

FIG. 11 illustrates one embodiment of a logic flow 2100. The logic flow 2100 may be representative of some or all of the operations executed by one or more embodiments described herein. More specifically, the logic flow 2100 may illustrate operations performed by the processor component 150 in executing at least the control routine 140, and/or performed by other component(s) of the capture device 100.

At 2110, a processor component of a computing device (e.g., the processor component 150 of the capture device 100) determines a priority level and/or the location of boundaries of a ROI in an image of a motion video (e.g., a ROI 887 in an image 883 of the motion video 880). As has been discussed, the priority level of a ROI is indicative of the importance of the portion of an image that is within that ROI relative to portions of the same image that are within another ROI and/or are not within any ROI. Again, the priority level may actually indicate that the portion of the image within the ROI has a priority level indicating its importance to be less than a portion of the same image that is not within any ROI such that the ROI could be regarded as a “region of lesser interest.” As has also been discussed, the locations of the boundaries of a ROI may be specified in an indication of the ROI as a measure of pixels and/or blocks of pixels (e.g., blocks or MPEG macroblocks) from an edge and/or a corner of an image. Further, where the compression encoding algorithm used to compress the video data to generate the compressed video data entails dividing the pixels of the image into such blocks, the locations of the boundaries of the ROI may be modified to align to boundaries of adjacent ones of those blocks.

At 2120, a frame representing the image as part of video data representing the motion video to which the image belongs is compressed as part of compressing that video data to generate compressed video data (e.g., the frames 133 of the video data 130 are compressed to generate corresponding frames 233 as part of compressing the video data 130 to generate the compressed video data 230). As has been discussed, a video bitstream may generated as part of the compressed video data, and the compressed video data may also include a message data made up of indications of aspects of the compression of the frames to generate the compressed frames, such as color depth, quantization parameters, etc.

At 2130, the compressed video data is augmented with indication(s) of the priority level and/or the locations of the boundaries of the ROI. As has been discussed, such augmentation may entail adding messages to message data of the compressed video data that provide such indications concerning the ROI.

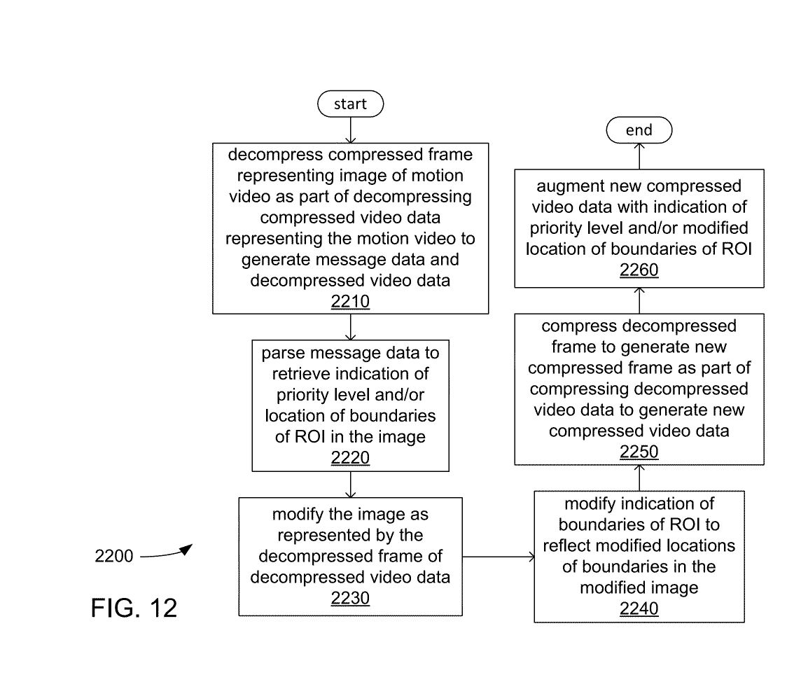

FIG. 12 illustrates one embodiment of a logic flow 2200. The logic flow 2200 may be representative of some or all of the operations executed by one or more embodiments described herein. More specifically, the logic flow 2200 may illustrate operations performed by the processor component 450 or 550 in executing at least the control routine 540, and/or performed by other component(s) of the transcoding device 400 or the controller 500, respectively.

At 2210, a processor component of a computing device (e.g., either the processor component 450 of the transcoding device 400, or the processor component 550 of the controller 500) decompresses a compressed frame representing an image of a motion video as part of decompressing compressed video data that represents the motion video and of which the compressed frame is a part (e.g., a compressed frame 233 representing an image 883 of the compressed video data 230 representing the motion video 880). In so doing, the processor component generates a decompressed video data (e.g., the decompressed video data 430) that includes a decompressed frame corresponding to the compressed frame.

At 2220, the message data making up part of the compressed video data is parsed to retrieve an indication of the priority level and/or locations of the boundaries of a ROI present within the image. Again, the priority level is indicative of the importance of the portion of the image that is within that ROI, and the locations of the boundaries of the ROI may be specified as a measure of pixels and/or blocks of pixels (e.g., blocks or MPEG macroblocks) from an edge and/or a corner of the image.

At 2230, the image, as represented by the decompressed frame of the decompressed video data, is modified. As has been discussed, such modifications may include one or more of resealing, cropping, addition of subtitles, combining with at least a portion of a frame of another motion video, etc. As has also been discussed, some of such modifications (e.g., cropping or resealing) may result in modifications to the quantity of pixels and/or blocks of pixels of the locations of the boundaries of the ROI from an edge or corner of the image. At 2240, the indication of the location of the boundaries of the ROI is modified to reflect such modified relative location(s).

At 2250, the decompressed frame representing the now modified image is compressed as part of compressing the decompressed video data to generate a new compressed video data (e.g., the decompressed frames of the decompressed video data 430 are compressed as part of generating the compressed video data 530). At 2260, the new compressed video data is augmented with indication(s) of the priority level and/or the now modified locations of the boundaries of the ROI. Again, such augmentation may entail adding messages to message data of the new compressed video data that provide such indications concerning the ROI.

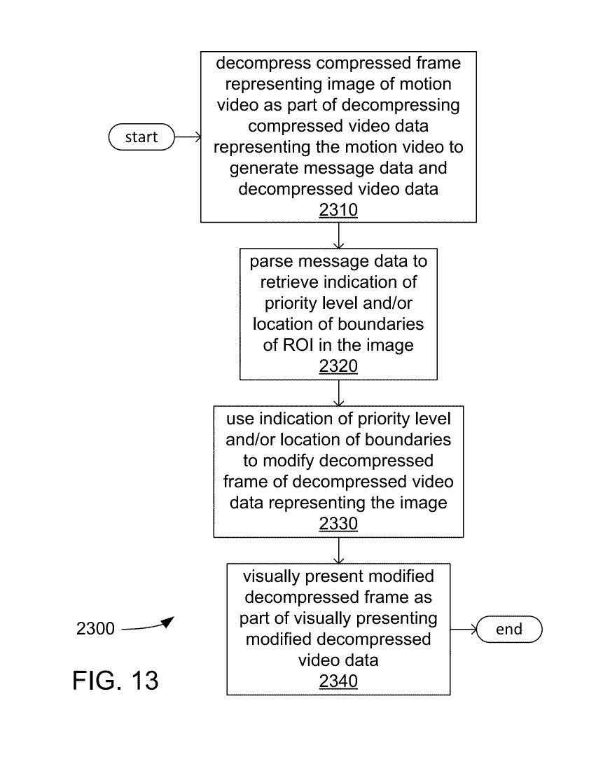

FIG. 13 illustrates one embodiment of a logic flow 2300. The logic flow 2300 may be representative of some or all of the operations executed by one or more embodiments described herein. More specifically, the logic flow 2300 may illustrate operations performed by the processor component 750 in executing at least the control routine 740, and/or performed by other component(s) of the viewing device 700.

At 2310, a processor component of a computing device (e.g., the processor component 750 of the viewing device 700) decompresses a compressed frame representing an image of a motion video as part of decompressing compressed video data that represents the motion video and of which the compressed frame is a part (e.g., a compressed frame representing an image 883 of the compressed video data 230 or 530 representing the motion video 880). In so doing, the processor component generates a decompressed video data (e.g., the decompressed video data 730) that includes a decompressed frame corresponding to the compressed frame.

At 2320, the message data making up part of the compressed video data is parsed to retrieve an indication of the priority level and/or locations of the boundaries of a ROI present within the image. Again, the priority level is indicative of the importance of the portion of the image that is within that ROI, and the locations of the boundaries of the ROI may be specified as a measure of pixels and/or blocks of pixels (e.g., blocks or MPEG macroblocks) from an edge and/or a corner of the image.

At 2330, the image, as represented by the decompressed frame of the decompressed video data, is modified using the priority level and/or locations of boundaries specified in the retrieved indication. As has been discussed, such modifications may include adding further visual information and/or employing image processing to selectively enhance aspects of a portion of the image within the ROI. At 2240, the now modified image is visually presented on as part of visually presenting the motion video on a display.

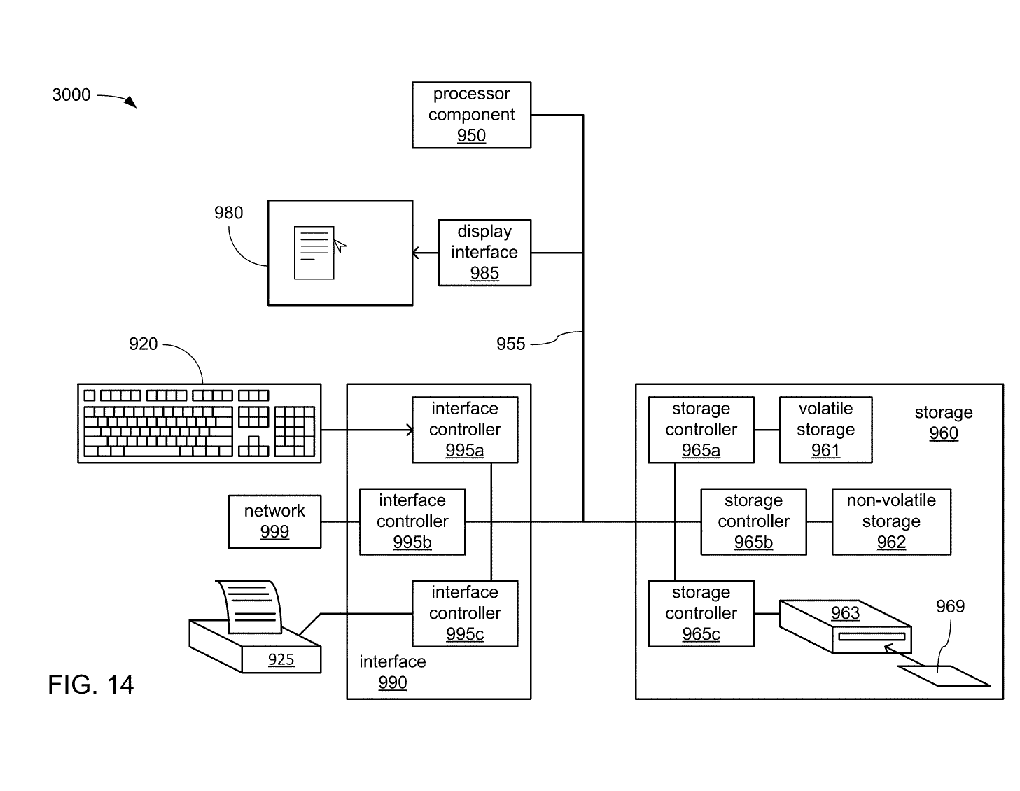

FIG. 14 illustrates an embodiment of an exemplary processing architecture 3000 suitable for implementing various embodiments as previously described. More specifically, the processing architecture 3000 (or variants thereof) may be implemented as part of one or more of the computing devices 100, 300, or 600, and/or the controller 400. It should be noted that components of the processing architecture 3000 are given reference numbers in which the last two digits correspond to the last two digits of reference numbers of at least some of the components earlier depicted and described as part of the computing devices 100, 300 and 600, as well as the controller 400. This is done as an aid to correlating components of each.

The processing architecture 3000 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor component, the processor component itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. A message (including a command, status, address or data message) may be one of such signals or may be a plurality of such signals, and may be transmitted either serially or substantially in parallel through any of a variety of connections and/or interfaces.

As depicted, in implementing the processing architecture 3000, a computing device includes at least a processor component 950, a storage 960, an interface 990 to other devices, and a coupling 955. As will be explained, depending on various aspects of a computing device implementing the processing architecture 3000, including its intended use and/or conditions of use, such a computing device may further include additional components, such as without limitation, a display interface 985.

The coupling 955 includes one or more buses, point-to-point interconnects, transceivers, buffers, crosspoint switches, and/or other conductors and/or logic that communicatively couples at least the processor component 950 to the storage 960. Coupling 955 may further couple the processor component 950 to one or more of the interface 990, the audio subsystem 970 and the display interface 985 (depending on which of these and/or other components are also present). With the processor component 950 being so coupled by couplings 955, the processor component 950 is able to perform the various ones of the tasks described at length, above, for whichever one(s) of the aforedescribed computing devices implement the processing architecture 3000. Coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor component 950 (corresponding to the processor components 350, 450 and 650) may include any of a wide variety of commercially available processors, employing any of a wide variety of technologies and implemented with one or more cores physically combined in any of a number of ways.

As previously discussed, the storage 960 (corresponding to the storages 360, 460 and 660) may be made up of one or more distinct storage devices based on any of a wide variety of technologies or combinations of technologies. More specifically, as depicted, the storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 such that it may include multiple distinct types of storage is in recognition of the commonplace use of more than one type of storage device in computing devices in which one type provides relatively rapid reading and writing capabilities enabling more rapid manipulation of data by the processor component 950 (but which may use a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of machine-readable storage medium 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage medium 969.

One or the other of the volatile storage 961 or the non-volatile storage 962 may include an article of manufacture in the form of a machine-readable storage media on which a routine including a sequence of instructions executable by the processor component 950 may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to storage medium such as a floppy diskette. By way of another example, the non-volatile storage 962 may be made up of banks of solid-state storage devices to store information, such as sequences of instructions, in a manner akin to a compact flash card. Again, it is commonplace to employ differing types of storage devices in a computing device at different times to store executable routines and/or data. Thus, a routine including a sequence of instructions to be executed by the processor component 950 may initially be stored on the machine-readable storage medium 969, and the removable media storage 963 may be subsequently employed in copying that routine to the non-volatile storage 962 for longer term storage not requiring the continuing presence of the machine-readable storage medium 969 and/or the volatile storage 961 to enable more rapid access by the processor component 950 as that routine is executed.

As previously discussed, the interface 990 (corresponding to the interfaces 190, 390 or 690) may employ any of a variety of signaling technologies corresponding to any of a variety of communications technologies that may be employed to communicatively couple a computing device to one or more other devices. Again, one or both of various forms of wired or wireless signaling may be employed to enable the processor component 950 to interact with input/output devices (e.g., the depicted example keyboard 920 or printer 925) and/or other computing devices through a network (e.g., the network 999) or an interconnected set of networks. In recognition of the often greatly different character of multiple types of signaling and/or protocols that must often be supported by any one computing device, the interface 990 is depicted as including multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 999 (perhaps a network made up of one or more links, smaller networks, or perhaps the Internet). The interface 995c may employ any of a variety of electrically conductive cabling enabling the use of either serial or parallel signal transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, a camera or camera array to monitor movement of persons to accept commands and/or data signaled by those persons via gestures and/or facial expressions, laser printers, inkjet printers, mechanical robots, milling machines, etc.

Where a computing device is communicatively coupled to (or perhaps, actually incorporates) a display (e.g., the depicted example display 980), such a computing device implementing the processing architecture 3000 may also include the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

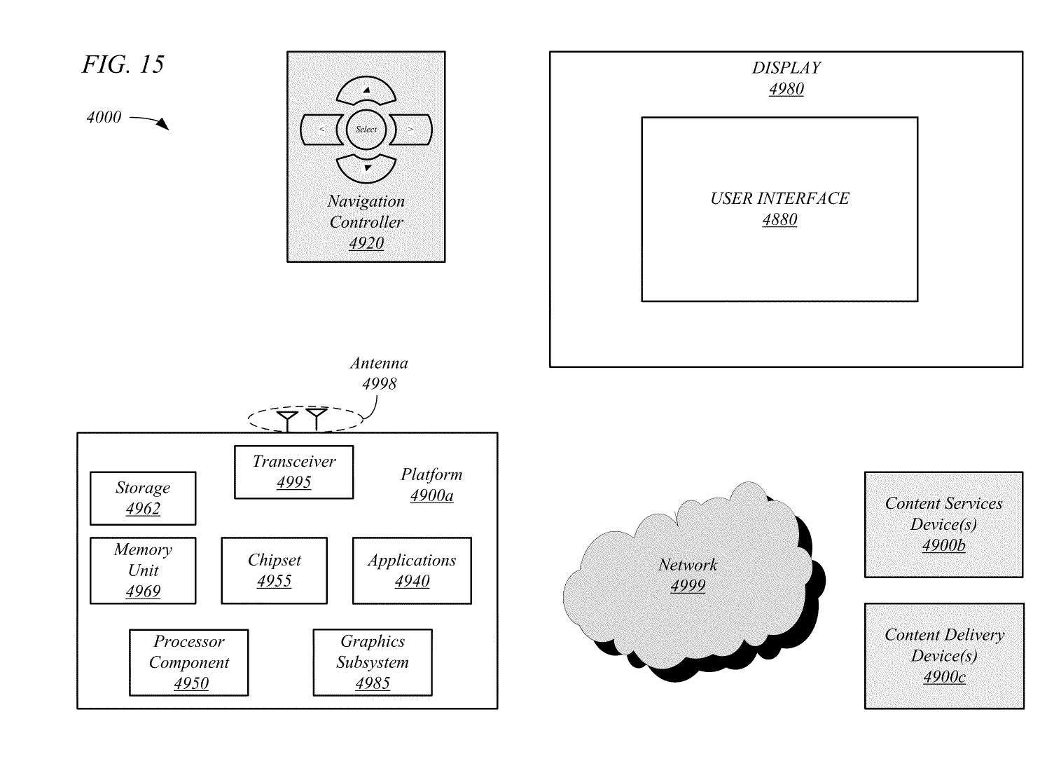

FIG. 15 illustrates an embodiment of a system 4000. In various embodiments, system 4000 may be representative of a system or architecture suitable for use with one or more embodiments described herein, such as the graphics processing system 1000; one or more of the computing devices 100, 300 or 600; and/or one or both of the logic flows 2100 or 2200. The embodiments are not limited in this respect.

As shown, system 4000 may include multiple elements. One or more elements may be implemented using one or more circuits, components, registers, processors, software subroutines, modules, or any combination thereof, as desired for a given set of design or performance constraints. Although a limited number of elements are shown and in a certain topology by way of example, it can be appreciated that more or less elements in any suitable topology may be used in system 4000 as desired for a given implementation. The embodiments are not limited in this context.

In embodiments, system 4000 may be a media system although system 4000 is not limited to this context. For example, system 4000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 4000 includes a platform 4900a coupled to a display 4980. Platform 4900a may receive content from a content device such as content services device(s) 4900c or content delivery device(s) 4900d or other similar content sources. A navigation controller 4920 including one or more navigation features may be used to interact with, for example, platform 4900a and/or display 4980. Each of these components is described in more detail below.

In embodiments, platform 4900a may include any combination of a processor component 4950, chipset 4955, memory unit 4969, transceiver 4995, storage 4962, applications 4940, and/or graphics subsystem 4985. Chipset 4955 may provide intercommunication among processor circuit 4950, memory unit 4969, transceiver 4995, storage 4962, applications 4940, and/or graphics subsystem 4985. For example, chipset 4955 may include a storage adapter (not depicted) capable of providing intercommunication with storage 4962.

Processor component 4950 may be implemented using any processor or logic device, and may be the same as or similar to one or more of processor components 150, 350 or 650, and/or to processor component 950 of FIG. 14.

Memory unit 4969 may be implemented using any machine-readable or computer-readable media capable of storing data, and may be the same as or similar to storage media 969 of FIG. 14.

Transceiver 4995 may include one or more radios capable of transmitting and receiving signals using various suitable wireless communications techniques, and may be the same as or similar to transceiver 995b in FIG. 14.

Display 4980 may include any television type monitor or display, and may be the same as or similar to one or more of displays 380 and 680, and/or to display 980 in FIG. 14.

Storage 4962 may be implemented as a non-volatile storage device, and may be the same as or similar to non-volatile storage 962 in FIG. 14.

Graphics subsystem 4985 may perform processing of images such as still or video for display. Graphics subsystem 4985 may be a graphics processing unit (GPU) or a visual processing unit (VPU), for example. An analog or digital interface may be used to communicatively couple graphics subsystem 4985 and display 4980. For example, the interface may be any of a High-Definition Multimedia Interface, DisplayPort, wireless HDMI, and/or wireless HD compliant techniques. Graphics subsystem 4985 could be integrated into processor circuit 4950 or chipset 4955. Graphics subsystem 4985 could be a stand-alone card communicatively coupled to chipset 4955.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

In embodiments, content services device(s) 4900b may be hosted by any national, international and/or independent service and thus accessible to platform 4900a via the Internet, for example. Content services device(s) 4900b may be coupled to platform 4900a and/or to display 4980. Platform 4900a and/or content services device(s) 4900b may be coupled to a network 4999 to communicate (e.g., send and/or receive) media information to and from network 4999. Content delivery device(s) 4900c also may be coupled to platform 4900a and/or to display 4980.

In embodiments, content services device(s) 4900b may include a cable television box, personal computer, network, telephone, Internet enabled devices or appliance capable of delivering digital information and/or content, and any other similar device capable of unidirectionally or bidirectionally communicating content between content providers and platform 4900a and/display 4980, via network 4999 or directly. It will be appreciated that the content may be communicated unidirectionally and/or bidirectionally to and from any one of the components in system 4000 and a content provider via network 4999. Examples of content may include any media information including, for example, video, music, medical and gaming information, and so forth.

Content services device(s) 4900b receives content such as cable television programming including media information, digital information, and/or other content. Examples of content providers may include any cable or satellite television or radio or Internet content providers. The provided examples are not meant to limit embodiments.

In embodiments, platform 4900a may receive control signals from navigation controller 4920 having one or more navigation features. The navigation features of navigation controller 4920 may be used to interact with a user interface 4880, for example. In embodiments, navigation controller 4920 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 4920 may be echoed on a display (e.g., display 4980) by movements of a pointer, cursor, focus ring, or other visual indicators displayed on the display. For example, under the control of software applications 4940, the navigation features located on navigation controller 4920 may be mapped to virtual navigation features displayed on user interface 4880. In embodiments, navigation controller 4920 may not be a separate component but integrated into platform 4900a and/or display 4980. Embodiments, however, are not limited to the elements or in the context shown or described herein.

In embodiments, drivers (not shown) may include technology to enable users to instantly turn on and off platform 4900a like a television with the touch of a button after initial boot-up, when enabled, for example. Program logic may allow platform 4900a to stream content to media adaptors or other content services device(s) 4900b or content delivery device(s) 4900c when the platform is turned “off” In addition, chip set 4955 may include hardware and/or software support for 5.1 surround sound audio and/or high definition 7.1 surround sound audio, for example. Drivers may include a graphics driver for integrated graphics platforms. In embodiments, the graphics driver may include a peripheral component interconnect (PCI) Express graphics card.

In various embodiments, any one or more of the components shown in system 4000 may be integrated. For example, platform 4900a and content services device(s) 4900b may be integrated, or platform 4900a and content delivery device(s) 4900c may be integrated, or platform 4900a, content services device(s) 4900b, and content delivery device(s) 4900c may be integrated, for example. In various embodiments, platform 4900a and display 4890 may be an integrated unit. Display 4980 and content service device(s) 4900b may be integrated, or display 4980 and content delivery device(s) 4900c may be integrated, for example. These examples are not meant to limit embodiments.

In various embodiments, system 4000 may be implemented as a wireless system, a wired system, or a combination of both. When implemented as a wireless system, system 4000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 4000 may include components and interfaces suitable for communicating over wired communications media, such as I/O adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 4900a may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 15.

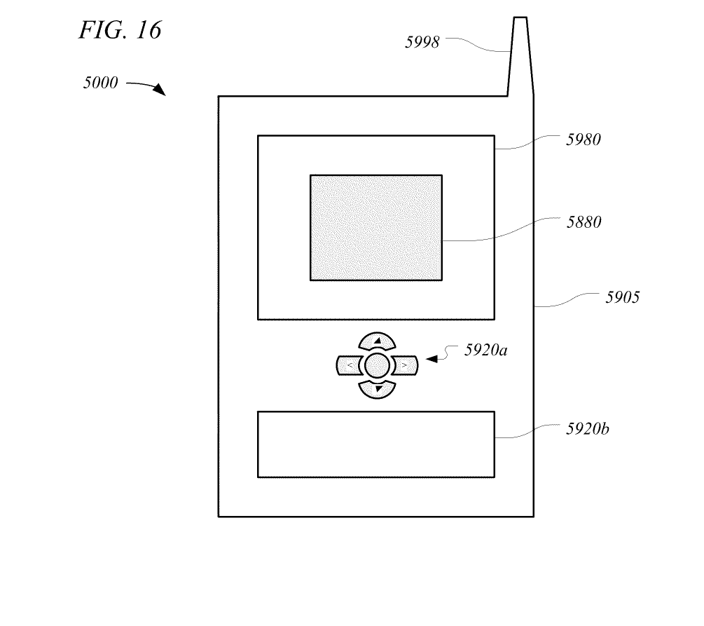

As described above, system 4000 may be embodied in varying physical styles or form factors. FIG. 16 illustrates embodiments of a small form factor device 5000 in which system 4000 may be embodied. In embodiments, for example, device 5000 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown, device 5000 may include a display 5980, a navigation controller 5920a, a user interface 5880, a housing 5905, an I/O device 5920b, and an antenna 5998. Display 5980 may include any suitable display unit for displaying information appropriate for a mobile computing device, and may be the same as or similar to display 4980 in FIG. 15. Navigation controller 5920a may include one or more navigation features which may be used to interact with user interface 5880, and may be the same as or similar to navigation controller 4920 in FIG. 15. I/O device 5920b may include any suitable I/O device for entering information into a mobile computing device. Examples for I/O device 5920b may include an alphanumeric keyboard, a numeric keypad, a touch pad, input keys, buttons, switches, rocker switches, microphones, speakers, voice recognition device and software, and so forth. Information also may be entered into device 5000 by way of a microphone. Such information may be digitized by a voice recognition device. The embodiments are not limited in this context.

More generally, the various elements of the computing devices described and depicted herein may include various hardware elements, software elements, or a combination of both. Examples of hardware elements may include devices, logic devices, components, processors, microprocessors, circuits, processor components, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

In Example 1, a device to compress motion video images includes a compression component to compress an image of a motion video to generate compressed video data representing the motion video, the image including a region of interest (ROI); and an augmenting component to augment the compressed video data with an indication of a location of a boundary of the ROI in the image.

In Example 2, which includes the subject matter of Example 1, the device may include an image sensor, and a capture component to operate the image sensor to capture at least an object in a field of view of the image sensor as the image.

In Example 3, which includes the subject matter of any of Examples 1-2, the device may include a ROI detection component to selectively generate the ROI and derive the location of the boundary of the ROI based on an identity of the object.

In Example 4, which includes the subject matter of any of Examples 1-2, the augmenting component may augment the compressed video data with an indication of a priority level of the ROI, the priority level indicative of a degree of importance of a portion of the image within the ROI compared at least to a degree of importance of another portion of the image not within the ROI.

In Example 5, which includes the subject matter of any of Examples 1-4, the device may include a distance sensor, and a ROI detection component to operate the distance sensor to determine at least one of the location of the boundary of the ROI or the priority level of the ROI based at least on a distance from the object.

In Example 6, which includes the subject matter of any of Examples 1-5, the device may include manually operable controls, and a user interface component to monitor the controls for a signal indicative of operation of the controls to provide at least one of the location of the boundary of the ROI or the priority level of the ROI.

In Example 7, which includes the subject matter of any of Examples 1-6, the device may include a decompression component to generate decompressed video data representing the motion video from another compressed video data representing the motion video and received from another device, and a parsing component to parse a message data of the other compressed video data to retrieve a message including the indication of the location of the boundary of the ROI.

In Example 8, which includes the subject matter of any of Examples 1-7, the device may include a modification component to modify the image in a manner that modifies the location of the ROI relative to at least one of an edge or a corner of the image and to modify the indication of the location of the boundary of the ROI to reflect modification of the location of the ROI.

In Example 9, which includes the subject matter of any of Examples 1-8, the modification of the image may include at least one of rescaling the image or cropping the image.

In Example 10, which includes the subject matter of any of Examples 1-9, the indication of the location of the boundary of the ROI may include at least one of an indication of a quantity of pixels from at least an edge or a corner of the image, or an indication of a quantity of blocks of pixels from at least an edge or a corner of the image.

In Example 11, which includes the subject matter of any of Examples 1-10, the augmenting component may augment the compressed video data with an indication of a priority level of the ROI, the priority level indicative of a degree of importance of a portion of the image within the ROI compared at least to a degree of importance of another portion of the image not within any ROI, and the degree of importance of the portion of the image within the ROI may include at least one of a degree of importance greater than the degree of importance of the other portion or a degree of importance less than the degree of importance of the other portion.

In Example 12, which includes the subject matter of any of Examples 1-11, the compressed video data may include a message data generated by the compression component, the message data including at least one message specifying an aspect of compression of a compressed frame of the compressed video data that represents the image, and the augmenting component may add another message including the indication of the location of the boundary of the ROI to the message data.

In Example 13, which includes the subject matter of any of Examples 1-12, the device may include at least one of a display to visually present the image or an interface to transmit the compressed video data to another device via a network.

In Example 14, a device to decompress motion video images includes a decompression component to generate decompressed video data representing a motion video from compressed video data representing the motion video and received from another device, and a parsing component to parse a message data of the compressed video data to retrieve a message including an indication of a location of a boundary of a ROI in an image of the motion video.

In Example 15, which includes the subject matter of Example 14, the device may include a modification component to modify the image in a manner that modifies the location of the ROI relative to at least one of an edge or a corner of the image and to modify the indication of the location of the boundary of the ROI to reflect modification of the location of the ROI.

In Example 16, which includes the subject matter of any of Examples 14-15, the modification of the image may include at least one of rescaling the image or cropping the image.

In Example 17, which includes the subject matter of any of Examples 14-16, the device may include a compression component to compress the image after modification of the image to generate another compressed video data including a compressed frame representing the image after modification of the image; and an augmenting component to augment the other compressed video data with an indication of the location of a boundary of the ROI after modification of the location of the boundary.

In Example 18, which includes the subject matter of any of Examples 14-17, the device may include a modification component to identify an object depicted in a portion of the image within the ROI and to selective modify the portion of the image within the ROI based at least on whether the object is a face.

In Example 19, which includes the subject matter of any of Examples 14-18, the parsing component may parse the message data to retrieve an indication of a priority level of the ROI, the priority level indicative of a degree of importance of a portion of the image within the ROI compared at least to a degree of importance of another portion of the image not within any ROI, and the device may include a modification component to selectively perform image processing to enhance the portion of the image within the ROI based on the priority level.

In Example 20, which includes the subject matter of any of Examples 14-19, the indication of the location of the boundary of the ROI may include at least one of an indication of a quantity of pixels from at least an edge or a corner of the image, or an indication of a quantity of blocks of pixels from at least an edge or a corner of the image.

In Example 21, which includes the subject matter of any of Examples 14-20, the parsing component to parse the message data to retrieve an indication of a priority level of the ROI, the priority level indicative of a degree of importance of a portion of the image within the ROI compared at least to a degree of importance of another portion of the image not within any ROI, and the degree of importance of the portion of the image within the ROI including at least one of a degree of importance greater than the degree of importance of the other portion or a degree of importance less than the degree of importance of the other portion

In Example 22, which includes the subject matter of any of Examples 14-21, the message data may include another message specifying an aspect of compression of a compressed frame of the compressed video data that represents the image.

In Example 23, which includes the subject matter of any of Examples 14-22, the device may include at least one of a display to visually present the image or an interface to receive the compressed video data from another device via a network.

In Example 24, a computing-implemented method for compressing motion video images includes compressing an image of a motion video to generate compressed video data representing the motion video, the image including a region of interest (ROI), and augmenting the compressed video data with an indication of a location of a boundary of the ROI in the image.

In Example 25, which includes the subject matter of Example 24, the method may include capturing at least an object in a field of view of an image sensor as the image.

In Example 26, which includes the subject matter of any of Examples 24-25, the method may include selectively generating the ROI based on an identity of the object.

In Example 27, which includes the subject matter of any of Examples 24-26, the method may include augmenting the compressed video data with an indication of a priority level of the ROI, the priority level indicative of a degree of importance of a portion of the image within the ROI compared at least to a degree of importance of another portion of the image not within the ROI.

In Example 28, which includes the subject matter of any of Examples 24-27, the method may include determining at least one of the location of the boundary of the ROI or the priority level of the ROI based at least on a distance of a capture device from the object.

In Example 29, which includes the subject matter of any of Examples 24-28, the method may include monitoring manually operable controls for a signal indicative of operation of the controls to provide at least one of the location of the boundary of the ROI or the priority level of the ROI.

In Example 30, which includes the subject matter of any of Examples 24-29, the method may include receiving another compressed video data representing the motion video from a device, generating decompressed video data representing the motion video from the other compressed video data, and parsing a message data of the other compressed video data to retrieve a message including the indication of the location of the boundary of the ROI.

In Example 31, which includes the subject matter of any of Examples 24-30, the method may include modifying the image in a manner that modifies the location of the ROI relative to at least one of an edge or a corner of the image, and modifying the indication of the location of the boundary of the ROI to reflect modification of the location of the ROI.

In Example 32, which includes the subject matter of any of Examples 24-31, the modification of the image may include at least one of rescaling the image or cropping the image.

In Example 33, which includes the subject matter of any of Examples 24-32, the indication of the location of the boundary of the ROI may include at least one of an indication of a quantity of pixels from at least an edge or a corner of the image, or an indication of a quantity of blocks of pixels from at least an edge or a corner of the image.

In Example 34, which includes the subject matter of any of Examples 24-33, the method may include augmenting the compressed video data with an indication of a priority level of the ROI, the priority level indicative of a degree of importance of a portion of the image within the ROI compared at least to a degree of importance of another portion of the image not within any ROI, and the degree of importance of the portion of the image within the ROI including at least one of a degree of importance greater than the degree of importance of the other portion or a degree of importance less than the degree of importance of the other portion.

In Example 35, which includes the subject matter of any of Examples 24-34, the compressed video data including a message data generated by the compression component, the message data including at least one message specifying an aspect of compression of a compressed frame of the compressed video data that represents the image; and the method may include generating the message data within the compressed video data, and adding another message including the indication of the location of the boundary of the ROI to the message data.

In Example 36, which includes the subject matter of any of Examples 24-35, the method may include at least one of visually presenting the image on a display or transmitting the compressed video data to a device via a network.

In Example 37, at least one machine-readable storage medium includes instructions that when executed by a computing device, cause the computing device to compress an image of a motion video to generate compressed video data representing the motion video, the image including a region of interest (ROI), and augment the compressed video data with an indication of a location of a boundary of the ROI in the image.

In Example 38, which includes the subject matter of Example 37, the computing device may be caused to capture at least an object in a field of view of an image sensor as the image.

In Example 39, which includes the subject matter of any of Examples 37-38, the computing device may be caused to selectively generate the ROI based on an identity of the object.

In Example 40, which includes the subject matter of any of Examples 37-39, the computing device may be caused to augment the compressed video data with an indication of a priority level of the ROI, the priority level indicative of a degree of importance of a portion of the image within the ROI compared at least to a degree of importance of another portion of the image not within the ROI.

In Example 41, which includes the subject matter of any of Examples 37-40, the computing device may be caused to determine at least one of the location of the boundary of the ROI or the priority level of the ROI based at least on a distance of a capture device from the object.

In Example 42, which includes the subject matter of any of Examples 37-41, the computing device may be caused to monitor manually operable controls for a signal indicative of operation of the controls to provide at least one of the location of the boundary of the ROI or the priority level of the ROI.

In Example 43, which includes the subject matter of any of Examples 37-42, the computing device may be caused to receive another compressed video data representing the motion video from a device, generate decompressed video data representing the motion video from the other compressed video data, and parse a message data of the other compressed video data to retrieve a message including the indication of the location of the boundary of the ROI.

In Example 44, which includes the subject matter of any of Examples 37-43, the computing device may be caused to modify the image in a manner that modifies the location of the ROI relative to at least one of an edge or a corner of the image, and modify the indication of the location of the boundary of the ROI to reflect modification of the location of the ROI.

In Example 45, which includes the subject matter of any of Examples 37-44, the modification of the image may include at least one of rescaling the image or cropping the image.

In Example 46, which includes the subject matter of any of Examples 37-45, the indication of the location of the boundary of the ROI including at least one of an indication of a quantity of pixels from at least an edge or a corner of the image, or an indication of a quantity of blocks of pixels from at least an edge or a corner of the image.

In Example 47, which includes the subject matter of any of Examples 37-46, the computing device may be caused to augment the compressed video data with an indication of a priority level of the ROI, the priority level indicative of a degree of importance of a portion of the image within the ROI compared at least to a degree of importance of another portion of the image not within any ROI, and the degree of importance of the portion of the image within the ROI including at least one of a degree of importance greater than the degree of importance of the other portion or a degree of importance less than the degree of importance of the other portion.

In Example 48, which includes the subject matter of any of Examples 37-47, the compressed video data may include a message data generated by the compression component, the message data including at least one message specifying an aspect of compression of a compressed frame of the compressed video data that represents the image; and the computing device may be caused to generate the message data within the compressed video data, and add another message including the indication of the location of the boundary of the ROI to the message data.

In Example 49, which includes the subject matter of any of Examples 37-48, the computing device caused to visually present the image on a display.

In Example 50, which includes the subject matter of any of Examples 37-49, the computing device may be caused to transmit the compressed video data to a device via a network.

In Example 51, at least one machine-readable storage medium may include instructions that when executed by a computing device, cause the computing device to perform any of the above.

In Example 52, a device to process motion video regions of interest may include means for performing any of the above.

1. A device comprising:
a compression component to compress an image of a motion video to generate compressed video data representing the motion video, the image comprising a region of interest (ROI); and
an augmenting component to augment the compressed video data with an indication of a location of a boundary of the ROI in the image.

2. The device of claim 1, comprising:
an image sensor; and
a capture component to operate the image sensor to capture at least an object in a field of view of the image sensor as the image.

3. The device of claim 2, comprising a ROI detection component to selectively generate the ROI and derive the location of the boundary of the ROI based on an identity of the object.

4. The device of claim 3, the augmenting component to augment the compressed video data with an indication of a priority level of the ROI, the priority level indicative of a degree of importance of a portion of the image within the ROI compared at least to a degree of importance of another portion of the image not within the ROI.

5. The device of claim 1, comprising:
a decompression component to generate decompressed video data representing the motion video from another compressed video data representing the motion video and received from another device; and
a parsing component to parse a message data of the other compressed video data to retrieve a message comprising the indication of the location of the boundary of the ROI.

6. The device of claim 5, comprising a modification component to modify the image in a manner that modifies a location of the ROI relative to at least one of an edge or a corner of the image and to modify the indication of the location of the boundary of the ROI to reflect modification of the location of the ROI.

7. The device of claim 1, comprising at least one of a display to visually present the image or an interface to transmit the compressed video data to another device via a network.

8. A device comprising:
a decompression component to generate decompressed video data representing a motion video from compressed video data representing the motion video and received from another device; and
a parsing component to parse a message data of the compressed video data to retrieve a message comprising an indication of a location of a boundary of a ROI in an image of the motion video.

9. The device of claim 8, comprising a modification component to modify the image in a manner that modifies a location of the ROI relative to at least one of an edge or a corner of the image and to modify the indication of the location of the boundary of the ROI to reflect modification of the location of the ROI.

10. The device of claim 9, comprising:
a compression component to compress the image after modification of the image to generate another compressed video data comprising a compressed frame representing the image after modification of the image; and
an augmenting component to augment the other compressed video data with an indication of the location of the boundary of the ROI after modification of the location of the ROI.

11. The device of claim 8, comprising a modification component to identify an object depicted in a portion of the image within the ROI and to selectively modify the portion of the image within the ROI based at least on whether the object is a face.

12. The device of claim 8, the parsing component to parse the message data to retrieve an indication of a priority level of the ROI, the priority level indicative of a degree of importance of a portion of the image within the ROI compared at least to a degree of importance of another portion of the image not within any ROI, and the device comprising a modification component to selectively perform image processing to enhance the portion of the image within the ROI based on the priority level.

13. The device of claim 8, the parsing component to parse the message data to retrieve an indication of a priority level of the ROI, the priority level indicative of a degree of importance of a portion of the image within the ROI compared at least to a degree of importance of another portion of the image not within any ROI, and the degree of importance of the portion of the image within the ROI comprising at least one of a degree of importance greater than the degree of importance of the other portion or a degree of importance less than the degree of importance of the other portion

14. A computer-implemented method comprising:
compressing an image of a motion video to generate compressed video data representing the motion video, the image comprising a region of interest (ROI); and
augmenting the compressed video data with an indication of a location of a boundary of the ROI in the image.

15. The computer-implemented method of claim 14, comprising capturing at least an object in a field of view of an image sensor as the image.

16. The computer-implemented method of claim 15, comprising selectively generating the ROI based on an identity of the object.

17. The computer-implemented method of claim 16, comprising augmenting the compressed video data with an indication of a priority level of the ROI, the priority level indicative of a degree of importance of a portion of the image within the ROI compared at least to a degree of importance of another portion of the image not within the ROI.

18. The computer-implemented method of claim 14, comprising augmenting the compressed video data with an indication of a priority level of the ROI, the priority level indicative of a degree of importance of a portion of the image within the ROI compared at least to a degree of importance of another portion of the image not within any ROI, and the degree of importance of the portion of the image within the ROI comprising at least one of a degree of importance greater than the degree of importance of the other portion or a degree of importance less than the degree of importance of the other portion.

19. The computer-implemented method of claim 14, comprising at least one of visually presenting the image on a display or transmitting the compressed video data to a device via a network.

20. At least one machine-readable storage medium comprising instructions that when executed by a computing device, cause the computing device to:
compress an image of a motion video to generate compressed video data representing the motion video, the image comprising a region of interest (ROI); and
augment the compressed video data with an indication of a location of a boundary of the ROI in the image.

21. The at least one machine-readable storage medium of claim 20, the computing device caused to capture at least an object in a field of view of an image sensor as the image.

22. The at least one machine-readable storage medium of claim 21, the computing device caused to selectively generate the ROI based on an identity of the object.

23. The at least one machine-readable storage medium of claim 22, the computing device caused to augment the compressed video data with an indication of a priority level of the ROI, the priority level indicative of a degree of importance of a portion of the image within the ROI compared at least to a degree of importance of another portion of the image not within the ROI.

24. The at least one machine-readable storage medium of claim 20, the indication of the location of the boundary of the ROI comprising at least one of an indication of a quantity of pixels from at least an edge or a corner of the image, or an indication of a quantity of blocks of pixels from at least an edge or a corner of the image.

25. The at least one machine-readable storage medium of claim 20, the compressed video data comprising a message data generated by the compression component, the message data comprising at least one message specifying an aspect of compression of a compressed frame of the compressed video data that represents the image, the computing device caused to:
generate the message data within the compressed video data; and
add another message comprising the indication of the location of the boundary of the ROI to the message data.
